(19) United States
(12) Patent Application Publication
(10) Pub. No.: US 2026/0006324 A1
(43) Pub. Date: Jan. 1, 2026

(54) FOCUS DETECTING APPARATUS, IMAGE PICKUP APPARATUS, FOCUS DETECTING METHOD, AND STORAGE MEDIUM

(71) Applicant: CANON KABUSHIKI KAISHA, Tokyo (JP)

(72) Inventors: AKIHIKO KANDA, Kanagawa (JP); KEISUKE KUDO, Kanagawa (JP)

(21) Appl. No.: 19/229,581

(22) Filed: Jun. 5, 2025

(30) Foreign Application Priority Data
Jun. 28, 2024 (JP) 2024-105619

(51) Int. Cl. H04N 23/67; H04N 23/695; H04N 25/704

(52) U.S. Cl. CPC H04N 23/672; H04N 23/695; H04N 25/704

(57) ABSTRACT

Focus detecting apparatuses, imaging pickup apparatuses, focus detecting methods, and storage mediums are provided herein. One or more focus detecting apparatuses include one or more processors that operate to perform a first focus detection using a signal from a first focus detecting pixel group in an image sensor having a plurality of focus detecting pixel groups configured to receive light beams passing through different pupil regions in an imaging optical system, and a second focus detection using a signal from a second focus detecting pixel group having a pupil division direction different from that of the first focus detecting pixel group, set a selected area from an area in which a plurality of focus detections are performed, and select a first defocus amount of an object based on a result of using defocus amounts acquired by the first focus detection and the second focus detection in the selected area.

### BACKGROUND

### Field of the Technology

The present disclosure relates to one or more embodiments of a focus detecting apparatus (control apparatus), an image pickup apparatus, a focus detecting method, and a storage medium.

### Description of the Related Art

Japanese Patent Laid-Open No. 2011-237215 discloses an image pickup apparatus that performs a focus detection using a phase-difference detecting method and an image sensor such as a CMOS sensor, in different focus detecting directions, and acquires a single defocus amount from defocus amounts in respective focus detecting directions.

In the configuration disclosed in Japanese Patent Laid-Open No. 2011-237215, in a case where one of the defocus amounts is an incorrect defocus amount, the combined defocus amount will also be an incorrect defocus amount, and an accurate defocus amount cannot be selected or calculated.

### SUMMARY

One or more embodiments of a focus detecting apparatus according to one or more aspects of the present disclosure may include one or more processors that operate to perform a first focus detection using a signal from a first focus detecting pixel group in an image sensor having a plurality of focus detecting pixel groups that operate to receive light beams passing through different pupil regions in an imaging optical system, and a second focus detection using a signal from a second focus detecting pixel group having a pupil division direction different from that of the first focus detecting pixel group and being of the plurality of focus detecting pixel groups of the image sensor; set a selected area from an area in which a plurality of focus detections are performed; and select a first defocus amount of an object based on a result of using defocus amounts acquired by the first focus detection and the second focus detection in the selected area. One or more image pickup apparatuses that may include the above one or more embodiments of a focus detecting or control apparatus, one or more focus detecting or control methods corresponding to the above one or more embodiments of a focus detecting or control apparatus, and a storage medium storing a program that causes a computer to execute the above one or more focus detecting or control methods also constitute one or more additional aspects of the present disclosure.

According to other aspects of the present disclosure, one or more additional focus detecting or control apparatuses, one or more additional image pickup apparatuses, one or more additional focus detecting or control methods, and one or more additional storage mediums are discussed herein. Further features of various embodiments of the present disclosure will become apparent from the following description of embodiments with reference to the attached drawings.

### BRIEF DESCRIPTION OF THE DRAWINGS

FIG. 1 is a block diagram of a camera system according to one or more embodiments of the present disclosure.

FIGS. 2A, 2B, and 2C illustrate a pixel array on an image sensor according to one or more embodiments of the present disclosure.

FIGS. 3A and 3B explain pixels according to one or more embodiments of the present disclosure.

FIG. 4 is a view explaining pupil division according to one or more embodiments of the present disclosure.

FIG. 5 is another view explaining the pupil division according to one or more embodiments of the present disclosure.

FIG. 6 illustrates a relationship between an image shift amount and a defocus amount according to one or more embodiments of the present disclosure.

FIG. 7 illustrates a layout of focus detecting areas according to one or more embodiments of the present disclosure.

FIG. 8 is a general flow of live-view imaging processing according to one or more embodiments of the present disclosure.

FIG. 9 is a flowchart of an imaging subroutine according to one or more embodiments of the present disclosure.

FIG. 10 is a flowchart of object tracking autofocus (AF) processing according to one or more embodiments of the present disclosure.

FIG. 11 is a flowchart of object detection and tracking processing according to one or more embodiments of the present disclosure.

FIGS. 12A, 12B, and 12C illustrate an example of a Convolutional Neural Network (CNN) that infers a likelihood of a specific area according to one or more embodiments of the present disclosure.

FIG. 13 is a flowchart of a flicker determination according to one or more embodiments of the present disclosure.

FIGS. 14A, 14B, and 14C explain the flicker influence on a pair of signals in vertical focus detection according to one or more embodiments of the present disclosure.

FIGS. 15A, 15B, 15C, and 15D are views illustrating waveforms when flicker occurs according to one or more embodiments of the present disclosure.

FIGS. 16A, 16B, 16C, and 16D are other views illustrating waveforms when flicker occurs according to one or more embodiments of the present disclosure.

FIG. 17 is a flowchart of defocus amount selection processing according to one or more embodiments of the present disclosure.

FIGS. 18A, 18B, 18C, 18D, 18E, 18F, 18G, and 18H are views illustrating a method of setting a defocus map according to one or more embodiments of the present disclosure.

FIGS. 19A, 19B, 19C, and 19D are other views illustrating a method of setting a defocus map according to one or more embodiments of the present disclosure.

FIGS. 20A, 20B, 20C, 20D, 20E, and 20F illustrate histograms of defocus maps according to one or more embodiments of the present disclosure.

FIGS. 21A, 21B, and 21C illustrate histograms of defocus maps using specific area information according to one or more embodiments of the present disclosure.

FIG. 22 is a flowchart of focus detection processing according to one or more embodiments of the present disclosure.

FIG. 23 illustrates an execution sequence of object tracking AF processing according to one or more embodiments of the present disclosure.

FIG. 24 is a flowchart of defocus amount selection processing according to one or more embodiments of the present disclosure.

FIGS. 25A, 25B, and 25C illustrate a defocus map setting method according to one or more embodiments of the present disclosure.

FIGS. 26A, 26B, and 26C are histograms of defocus maps according to one or more embodiments of the present disclosure.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,”“assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

### Details of One or More Embodiments

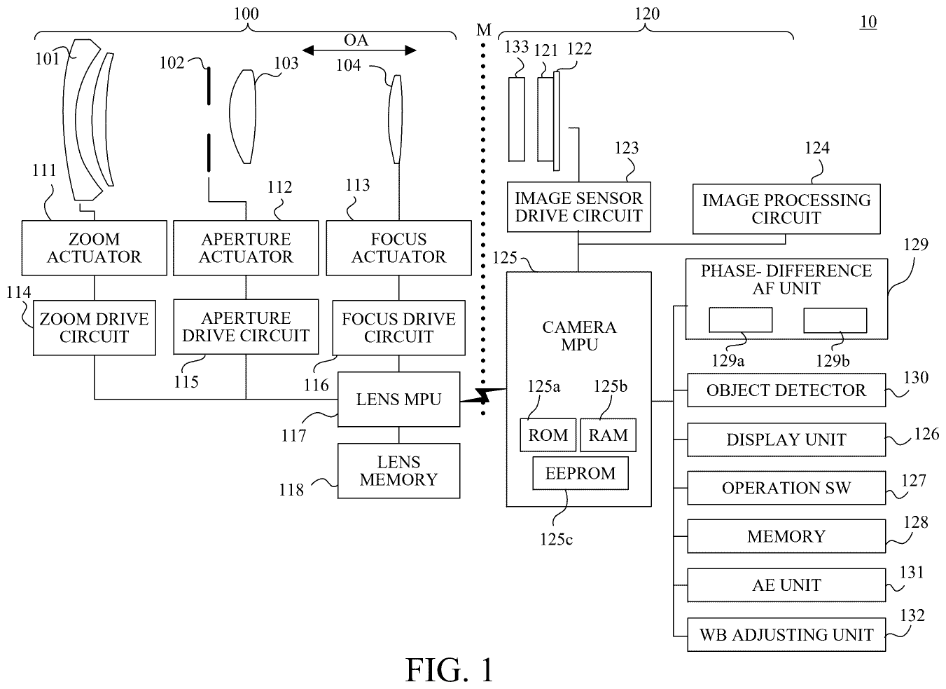

FIG. 1 is a block diagram of an imaging system 10 including a camera body (image pickup apparatus) 120 according to one or more embodiments. A lens unit (interchangeable lens) 100 is attached to and detachable from the camera body 120 as a digital camera via a mount M indicated by a dotted line in FIG. 1. The camera body 120 may be one integrated with a lens unit. This camera body 120 is not limited to the digital camera but may be applicable to another image pickup apparatus such as a video camera.

The lens unit 100 includes an imaging optical system and a drive/control system, and the imaging optical system includes a first lens unit 101, an aperture stop (diaphragm) 102, a second lens unit 103, and a focus lens unit group (simply referred to as focus lens hereinafter) 104 as a focusing element. The imaging optical system receives light from an object and forms an object image.

The first lens unit 101 is disposed closest to an object (the foremost side) in the imaging optical system, and is movable in an optical axis direction in which an optical axis OA extends. The aperture stop 102 adjusts a light amount by changing its aperture diameter, and functions as a shutter that controls the exposure time in capturing a still image. The aperture stop 102 and the second lens unit 103 are movable together in the optical axis direction, and achieve zooming in association with the movement of the first lens unit 101. The focus lens 104 moves in the optical axis direction to perform focusing. Autofocus (AF) is provided by controlling the position of the focus lens 104 in the optical axis direction according to a focus detection result, which will be described below.

The lens drive/control system includes a zoom actuator 111, an aperture actuator 112, a focus actuator 113, a zoom drive circuit 114, an aperture drive circuit 115, a focus drive circuit 116, a lens MPU (processor) 117, and a lens memory 118.

During zooming, the zoom drive circuit 114 drives the first lens unit 101 and the second lens unit 103 in the optical axis direction by driving the zoom actuator 111. The aperture drive circuit 115 drives the aperture actuator 112 to operate the aperture stop 102 for an aperture operation or a shutter operation.

During focusing, the focus drive circuit 116 moves the focus lens 104 in the optical axis direction by driving the focus actuator 113. The focus drive circuit 116 has a function as a position detector configured to detect the current position of the focus lens 104 (referred to as a focus position hereinafter).

The lens MPU 117 is a computer that performs calculations and processing relating to the lens unit 100, and controls the zoom drive circuit 114, the aperture drive circuit 115, and the focus drive circuit 116. The lens MPU 117 is connected communicably to a camera MPU 125 through a communication terminal in the mount M and communicates commands and data with the camera MPU 125. For example, the lens MPU 117 transmits lens information to the camera MPU 125 according to a request from the camera MPU 125. This lens information includes information about a focus position, a position in the optical axis direction and a diameter of an exit pupil of the imaging optical system, and a position in the optical axis direction and a diameter of a lens frame that limits a light beam from the exit pupil.

The lens MPU 117 controls the zoom drive circuit 114, the aperture drive circuit 115, and the focus drive circuit 116 according to a request from the camera MPU 125. The lens memory 118 stores optical information necessary for AF. The camera MPU 125 controls the lens unit 100 by executing programs stored in built-in nonvolatile memory and lens memory 118.

The camera body 120 includes an optical low-pass filter 121, an image sensor 122, and a drive/control system. The optical low-pass filter 121 is provided to reduce false colors and moiré.

The image sensor 122 includes a CMOS sensor and its peripheral circuits. The image sensor 122 photoelectrically converts an object image (optical image) formed by an imaging optical system, and outputs an imaging signal and a pair of focus detecting signals (two-image signals). In the image sensor 122, a plurality of imaging pixels of m pixels in the horizontal direction and n pixels in the vertical direction orthogonal to the horizontal direction (m and n are integers of 2 or more) are arranged. Each imaging pixel includes a pair of focus detecting pixels, as will be described below, and has a pupil division function that allows focus detection using a phase-difference detecting method.

The image sensor 122 includes a CMOS sensor and its peripheral circuits, and performs photoelectric conversion for an object image (optical image) formed by the imaging optical system, and outputs an image signal and a pair of focus detecting signals (two-image signals). The image sensor 122 is disposed with a plurality of image pixels, m pixels in the horizontal direction and n pixels in the vertical direction orthogonal to the horizontal direction, where m and n are integers of 2 or more. Each image pixel includes a pair of focus detecting pixels as described later, and has a pupil division function that enables focus detection using a phase-difference detecting method.

The drive/control system has an image sensor drive circuit 123, a shutter 133, an image processing circuit 124, the camera MPU (selector) 125, a display unit 126, an operation switch (SW) 127, and the memory 128, a phase-difference AF unit 129, an object detector 130, an auto-exposure (AE) unit 131, and a white balance (WB) adjusting unit 132.

The image sensor drive circuit 123 controls charge accumulation and signal readout in the image sensor 122, and also A/D-converts the imaging signal and the pair of focus detecting signals output from the image sensor 122, and outputs the A/D-converted result to the image processing circuit 124 and camera MPU 125. The image processing circuit 124 performs image processing such as y conversion, color interpolation processing, and compression encoding processing for the digital imaging signal from the image sensor drive circuit 123 to generate image data.

The camera MPU 125 is a computer that executes calculations and processing relating to the camera body 120, and controls the image sensor drive circuit 123, the image processing circuit 124, the display unit 126, the phase-difference AF unit 129, the object detector 130, and the AE unit 131 and the WB adjustment unit 132. The camera MPU 125 is communicably connected to the lens MPU 117 through the communication terminal of the mount M, and communicates commands and data with the lens MPU 117. For example, the camera MPU 125 requests the lens MPU 117 for lens information and optical information, or requests the lens MPU 117 to drive the first lens unit 101, the focus lens 104 or the aperture stop 102. The camera MPU 125 receives lens information and optical information transmitted from lens MPU 117.

The camera MPU 125 includes a ROM 125a that stores a variety of programs, a RAM 125b that stores variables, and an EEPROM 125c that stores a variety of parameters. The camera MPU 125 executes various processing including AF processing, which will be described below, according to programs stored in the ROM 125a. The camera MPU 125 generates two-image data from the pair of digital focus detecting signals from the image sensor drive circuit 123 and outputs it to the phase-difference AF unit 129.

The shutter 133 has a focal plane shutter structure, and drives the focal plane shutter according to a command from a shutter drive circuit built into the shutter 133 based on an instruction from the camera MPU 125. The shutter 133 shields light to the image sensor 122 while a signal from the image sensor 122 is being read out. While exposure is being performed, the focal plane shutter is opened and an imaging light beam is guided to the image sensor 122.

The display unit 126 includes an LCD or the like, and displays information regarding an imaging mode, a preview image before imaging, a confirmation image after imaging, a focus state, etc. The operation SW 127 includes a power switch, a release (imaging instruction) switch, a zoom switch, an imaging mode selection switch, and the like. The memory 128 is a flash memory that is removably attached to the camera body 120, and records images for recording acquired by imaging.

The phase-difference AF unit 129 performs focus detection using two-image data generated by the camera MPU 125. The image sensor 122 photoelectrically converts a pair of optical images formed by light beams that have passed through different pairs of pupil regions in the exit pupil of the imaging optical system, and outputs a pair of focus detecting signals. The phase-difference AF unit 129 performs a correlation calculation for the two-image data generated from the pair of focus detecting signals by the camera MPU 125 to calculate an image shift amount as a phase difference between them, and calculates (acquires) a defocus amount as information regarding the focus from the calculated image shift amount. The camera MPU 125 calculates a drive amount of the focus lens 104 based on the defocus amount calculated by the phase-difference AF unit 129, and transmits a focus control instruction including the drive amount to the lens MPU 117. The phase-difference AF unit 129 and the camera MPU 125 form a focus detecting apparatus.

The phase-difference AF unit 129 also sets the layout of the area where focus detection is performed. Details will be given later.

Thus, one or more embodiments perform imaging-surface phase-difference AF using the output of the image sensor 122, without using a dedicated focus-detecting AF sensor. In one or more embodiments, the phase-difference AF unit 129 includes an acquiring unit 129a configured to acquire two-image data and a calculator 129b configured to calculate a defocus amount. At least one of the acquiring unit 129a and the calculator 129b may be provided in the camera MPU 125.

The object detector 130 performs object detection using dictionary data generated by machine learning. In one or more embodiments, the object detector 130 uses dictionary data for each object in order to detect multiple types of objects. Each dictionary data is, for example, data in which the characteristics of the corresponding object are registered. The object detector 130 performs object detection while sequentially switching between dictionary data for each object. The dictionary data for each object is stored in a dictionary data memory (ROM 125a in the camera MPU 125). Therefore, a plurality of dictionary data are stored in the dictionary data memory. The camera MPU 125 determines which dictionary data from the plurality of dictionary data to use for object detection based on the object priority set in advance and the settings of the camera body 120.

The AE unit 131 performs AE control by performing photometry (light metering) using image data for AE acquired from the image processing circuit 124. More specifically, the AE unit 131 acquires luminance information on image data for AE, and calculates an F-number (aperture value), a shutter speed, and ISO speed as an imaging condition from a difference between the exposure amount acquired from the luminance information and the preset exposure amount. The AE unit 131 performs AE by controlling the aperture value, shutter speed, and ISO speed to the calculated values.

The WB adjustment unit 132 calculates the WB of the image data for WB adjustment acquired from the image processing circuit 124, and adjusts the WB by adjusting RGB color weights according to a difference between the calculated WB and a predetermined proper WB.

The camera MPU 125 can select an image height range for the phase-difference AF, AE, and WB adjustment according to a position, size, and the like of an object in an imaging area detected by the object detector 130.

### Image Sensor 122

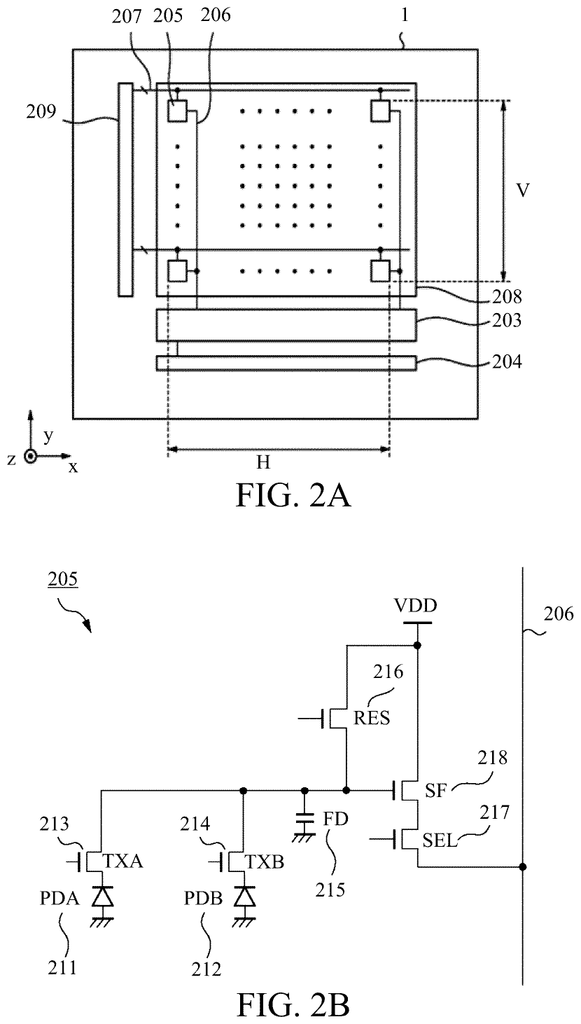

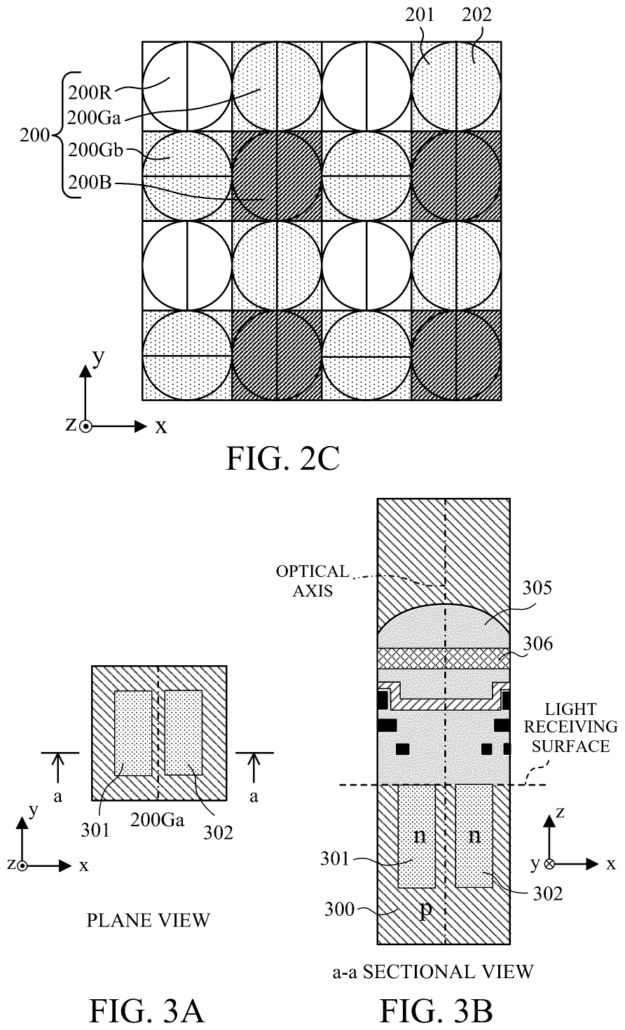

FIGS. 2A, 2B, and 2C illustrate pixel arrays on an imaging surface of the image sensor 122 as a two-dimensional CMOS sensor. FIG. 2A is a schematic diagram of an example of the overall configuration of the image sensor 122. The image sensor 122 includes a pixel array unit 208, a vertical selection circuit 209, a column circuit 203, and a horizontal selection circuit 204.

A plurality of pixels 205 are arranged in a matrix in the pixel array unit 208. When the output of the vertical selection circuit 209 is input to the pixels 205 via a pixel drive wiring group 207, pixel signals of the pixels 205 in a row selected by the vertical selection circuit 209 are read out to the column circuit 203 via the output signal line 206 on a row-by-row basis. It is possible to provide one output signal line 206 for each pixel column or for each plurality of pixel columns, or a plurality of output signal lines 206 for each pixel column. Signals read out in parallel are input to the column circuit 203 via the plurality of output signal lines 206, and the column circuit 203 performs processing such as signal amplification, noise removal, and A/D conversion, and stores the processed signals. The horizontal selection circuit 204 sequentially, randomly, or simultaneously selects the signals held in the column circuit 203, and the selected signals are output to the outside of the image sensor 122 via a horizontal output line and an output unit (not illustrated).

Thus, the operation of outputting pixel signals of the row selected by the vertical selection circuit 209 to the outside of the image sensor 122 is sequentially performed while the row selected by the vertical selection circuit 209 is changed, whereby a two-dimensional image signal or phase difference signal can be read out from the image sensor 122.

FIG. 2B is an equivalent circuit diagram of a pixel 205. Each pixel 205 has two photodiodes (PDA 211, PDB 212) that are photoelectric converters. A signal charge generated by the photoelectric conversion by the PDA 211 in accordance with an incident light amount and accumulated is transferred to a floating diffusion portion (FD) 215 constituting a charge accumulator via a transfer switch (TXA) 213. A signal change generated by the photoelectric conversion by the PDB 212 in accordance with an incident light amount and accumulated is transferred to the FD 215 via a transfer switch (TXB) 214. A reset switch (RES) 216, when turned on, resets the FD 215 to the voltage of a constant voltage source VDD. The PDA 211 and the PDB 212 can be reset by turning on the RES 216, the TXA 213, and the TXB 214 simultaneously.

When a selection switch (SEL) 217 for selecting a pixel is turned on, an amplification transistor (SF) 218 converts the signal charge accumulated in the FD 215 into a voltage, and the converted signal voltage is output from the pixel to the output signal line 206. Each of the gates of TXA213, TXB214, RES216, and SEL217 is connected to pixel drive wiring group 207 and controlled by vertical selection circuit 209.

In the following description of one or more embodiments, the signal charge accumulated in the photoelectric converter is electrons, the photoelectric converter is formed of an N-type semiconductor and separated by a P-type semiconductor, but the signal charge may be holes, the photoelectric converter may be formed of a P-type semiconductor and separated by an N-type semiconductor.

A description will now be given of an operation of reading out signal charge from the PDA 211 and PDB 212 a predetermined charge accumulation time after the PDA 211 and PDB 212 are reset in a pixel having the above configuration. First, the SEL 217 of the row selected by the vertical selection circuit 209 is turned on, and the source of the SF 218 is connected to the output signal line 206, and the output signal line 206 is in a state in which a voltage corresponding to the voltage of the FD 215 is read out. Next, the RES 216 is turned on/off, and the potential of the FD 215 is reset. Thereafter, the system waits until the output signal line 206, which has received the voltage fluctuation of the FD 215, becomes statically settled, and the column circuit 203 takes in the statically settled voltage of the output signal line 206 as a signal voltage N, processes the signal, and stores it.

Thereafter, the TXA 213 is turned on/off, and the signal charge accumulated in the PDA 211 is transferred to the FD 215. The voltage of the FD 215 drops by an amount corresponding to the signal charge amount accumulated in the PDA 211. Thereafter, the system waits until the output signal line 206 that has been subjected to the voltage fluctuation of the FD 215 is stabilized, and the stabilized voltage of the output signal line 206 is taken in by the column circuit 203 as a signal voltage A, and is subjected to signal processing and saved.

Thereafter, the TXB 214 is turned on/off, and the signal charge accumulated in the PDB 212 is transferred to the FD 215. The voltage of the FD 215 drops by an amount corresponding to the signal charge amount accumulated in the PDB 212. Thereafter, the system waits until the output signal line 206 which has been subjected to the voltage fluctuation of the FD 215 is stabilized, and the stabilized voltage of the output signal line 206 is taken in by the column circuit 203 as a signal voltage (A+B), and is subjected to signal processing and saved.

From a difference between the signal voltage N and the signal voltage A thus taken in, an A-signal corresponding to the signal charge amount accumulated in the PDA 211 can be acquired. From a difference between the signal voltage A and the signal voltage (A+B), a B-signal according to the signal charge amount accumulated in the PDB 212 can be acquired. This difference calculation may be performed by the column circuit 203, or may be performed after output from the image sensor 122. A phase difference signal can be acquired by using the A-signal and the B-signal, respectively, and an image signal can be acquired by adding the A-signal and the B-signal together. Alternatively, when the difference calculation is performed after output from the image sensor 122, an image signal may be acquired by taking the difference between the signal voltage N and the signal voltage (A+B).

The signal voltage N, the signal voltage A, and the signal voltage B may be read out by performing drive similar to the drive for reading out the signal voltage N and the signal voltage A for the PDB 212 instead of the PDA 211. In that case, the A-signal and the B-signal acquired from the signal voltage A and the signal voltage B, respectively, can be used as they are as phase difference signals, and an image signal can be acquired by adding up the signal voltage A and the signal voltage B, or the A-signal and the B-signal.

In one or more embodiments, the pixel from which the A-signal is acquired will be referred to as a first focus detecting pixel, and the pixel from which the B-signal is acquired will be referred to as a second focus detecting pixel.

FIG. 2C is an array diagram illustrating imaging pixels in an area of 4 columns by 4 rows. A pixel unit 200 including 2 columns×2 rows of imaging pixels includes a pixel 200R with a spectral sensitivity of R (red) located at the upper left corner, pixels 200Ga and 200Gb with a spectral sensitivity of G (green) located at the upper right and lower left corners, and a pixel 200B with a spectral sensitivity of B (blue) located at the lower right corner. Each imaging pixel includes a first focus detecting pixel 201 and a second focus detecting pixel 202. In the pixels 200R, 200Ga, and 200B, the first focus detecting pixel 201 and the second focus detecting pixel 202 are arranged in the horizontal direction (row direction), and in the pixel 200Gb, the first focus detecting pixel 201 and the second focus detecting pixel 202 are arranged in the vertical direction (column direction).

FIGS. 3A and 3B explain pixels. FIG. 3A illustrates the pixel 200Ga when viewed from the incident side (+z side) of the image sensor 122, and FIG. 3B illustrates the pixel structure of the pixel 200Ga when “a-a” section in FIG. 3A is viewed from the −y side. In the pixel 200Ga, a microlens 305 for condensing incident light is formed on the incident side, and photoelectric converters 301 and 302 divided into two in the x direction are formed. The photoelectric converters 301 and 302 correspond to the first focus detecting pixel 201 and the second focus detecting pixel 202, respectively.

The photoelectric converters 301 and 302 may be pin structure photodiodes in which an intrinsic layer is sandwiched between a p-type layer and an n-type layer, or may be pn junction photodiodes in which the intrinsic layer is omitted. A color filter 306 is formed between the microlens 305 and the photoelectric converters 301 and 302. The spectral transmittance of the color filter may be changed for each focus detecting pixel, or the color filter may be omitted.

Two light beams incident on the pixel 200Ga from the pair of pupil regions are each condensed by the microlens 305 and separated by a color filter 306, and then received by photoelectric converters 301 and 302. In each photoelectric converter, electrons and holes are generated in pairs according to a received light amount, and after they are separated by a depletion layer, negatively charged electrons are accumulated in the n-type layer. On the other hand, holes are discharged to the outside of the image sensor 122 through the p-type layer connected to an unillustrated constant voltage source. Electrons accumulated in the n-type layer of each photoelectric converter are transferred to a capacitance unit (FD) via a transfer gate and converted into a voltage signal.

FIG. 4 is a view illustrating pupil division. The lower part of FIG. 4 illustrates the pixel structure when the “a-a” section in FIG. 3A is viewed from the +y side, and the upper part of FIG. 4 illustrates a pupil plane at pupil distance DS. In FIG. 4, the x-axis and y-axis of the pixel structure are inverted relative to FIG. 3B in order to correspond to the coordinate axes of the pupil plane. The pupil plane corresponds to the entrance pupil position of the image sensor 122. In one or more embodiments, by offsetting (shrinking) a microlens position in each pixel from the center of the image sensor 122, the entrance pupils in each pixel overlap each other to form a single entrance pupil for the image sensor 122. The pupil distance DS is a distance between the pupil plane and the imaging surface, and will be referred to as a sensor-pupil distance hereinafter.

As illustrated in FIG. 4, the first pupil region (first partial pupil region) 501 of the first focus detecting pixel 201 has an approximately conjugate relationship with the light receiving surface of the photoelectric converter 301 whose center of gravity is decentered in the −x direction due to the microlens. The first pupil region 501 is a pupil region through which a light beam to be received by the first focus detecting pixel 201 passes. The center of gravity of the first pupil region 501 is eccentric to the +X side on the pupil plane. The second pupil region (second partial pupil region) 502 of the second focus detecting pixel 202 has an approximately conjugate relationship with the light receiving surface of the photoelectric converter 302 whose center of gravity is decentered in the +x direction due to the microlens. The second pupil region 502 is a pupil region through which a light beam to be received by the second focus detecting pixel 202 passes. The center of gravity of the second pupil region 502 is eccentric to the −X side on the pupil plane. The pupil region 500 is a pupil region through which a light beam to be received by the entire pixel 200G including the photoelectric converters 301 and 302 (the first focus detecting pixel 201 and the second focus detecting pixel 202) passes.

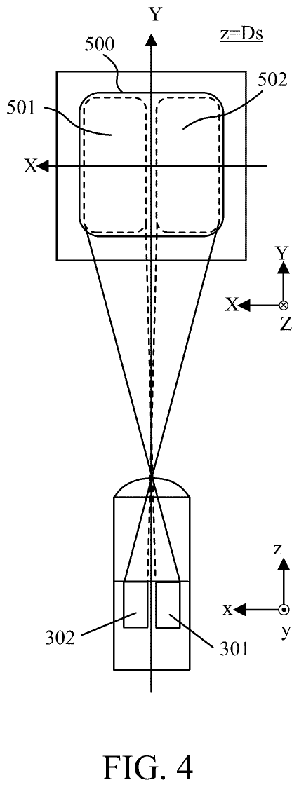

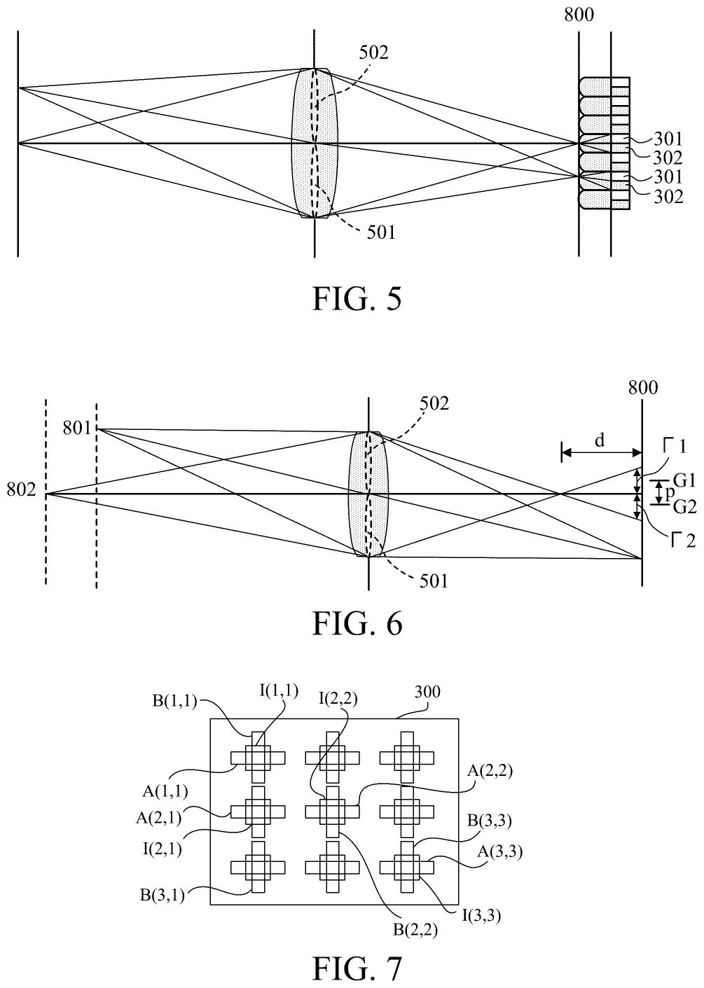

As illustrated in FIG. 5, light beams that enter the imaging optical system from the object (vertical line on the left in FIG. 5) and pass through the first pupil region 501 and the second pupil region 502 enter corresponding imaging pixels at different angles and are received by the photoelectric converters 301 and 302. The pixels 200R, 200Ga, and 200B perform pupil division in the horizontal direction (x-axis direction in FIG. 4), and the pixel 200Gb performs pupil division in the vertical direction (y-axis direction in FIG. 4). Imaging pixels each having a first focus detecting pixel and a second focus detecting pixel receive light beams passing through the first pupil region 501 and the second pupil region 502. A pair of focus detecting signals is generated by combining the respective output signals of the first focus detecting pixel 201 and the second focus detecting pixel 202 in the plurality of imaging pixels. Adding the output signals of the first focus detecting pixel 201 and the second focus detecting pixel 202 of the plurality of imaging pixels can generate an imaging signal with a resolution of the effective pixel number N (=m×n). The other focus detecting signal may be generated by subtracting one of the pair of focus detecting signals from the imaging signal.

One or more embodiments provide all the imaging pixels on the image sensor 122 with the first and second focus detecting pixels, but two imaging pixels may be used as the first and second focus detecting pixels, and part of the imaging pixels may be provided with the first and second focus detecting pixels.

### Relationship Between Defocus Amount and Image Shift Amount

FIG. 6 illustrates a relationship between a defocus amount and an image shift amount of two-image data. Reference numeral 800 denotes an imaging surface of the image sensor 122, and the pupil surface of the image sensor 122 is divided into two, a first pupil region 501 and a second pupil region 502. A defocus amount d has a magnitude (absolute value) of |d|, which is a distance from an imaging position (image position) of an object image to the imaging surface 800. A front focus state where the image position is located on the object side of the imaging surface 800 has a negative sign (d<0), and a rear focus state where the image position is located on the opposite side to the object of the imaging surface 800 has a positive sign (d>0). An in-focus state in which the image position is located on the imaging surface 800 is expressed as d=0.

In FIG. 6, object 801 illustrates an in-focus state (d=0), and object 802 illustrates a front focus state (d<0). The front focus state (d<0) and the rear focus state (d>0) will be collectively referred to as a defocus state (|d|>0).

In the front focus state, among the light beams from the object 802, the light beams that have passed through each of the first pupil region 501 and the second pupil region 502 are once condensed, then spread with widths Γ1 and Γ2 at centers of the center of gravity positions G1 and G2 of the light beams, and form a blurred optical image on the imaging surface 800. These blurred images are received by the first focus detecting pixel 201 and the second focus detecting pixel 202 in each imaging pixel on the imaging surface 800, and thereby the first focus detecting signal and the second focus detecting pixel as a pair of focus detecting signals are generated. The first focus detecting signal and the second focus detecting signal are recorded as blurred images in which the object 802 is spread to blur widths Γ1 and Γ2 at the center of gravity positions G1 and G2 on the imaging surface 800, respectively. The blur widths Γ1 and Γ2 increase approximately in proportion to an increase in the magnitude |d| of the defocus amount d. Similarly, the magnitude |p| of an image shift amount p between the first focus detecting signal and the second focus detecting signal (=difference G1−G2 in the center of gravity position between the light beams) also increases approximately in proportion to the increase of the magnitude |d| of the defocus amount d. The rear focus state (d>0) is similar, although the image shift direction between the first focus detecting signal and the second focus detecting signal is opposite to that of the front focus state.

In one or more embodiments, a difference in the center of gravity of the incident angle distributions in the first pupil region 501 and the second pupil region 502 will be referred to as a base length. A relationship between the defocus amount d and the image shift amount p on the imaging surface 800 is approximately similar to a relationship between the base length and the sensor-pupil distance. Since the magnitude of the image shift amount between the first focus detecting signal and the second focus detecting signal increases as the defocus amount d increases, the phase-difference AF unit 129 converts the image shift amount into the defocus amount using the conversion coefficient calculated based on the base length and this relationship.

In the following description, calculating a defocus amount using a pair of focus detecting signals from a focus detecting pixel group (focus detecting groups) that are divided in the horizontal direction (lateral direction) like the pixel 200Ga will be referred to as horizontal focus detection (first focus detection). Calculating a defocus amount using a pair of focus detecting signals from a focus detecting pixel group (focus detecting groups) that are divided in the vertical direction (longitudinal direction) like the pixel 200Gb will be referred to as vertical focus detection (second focus detection).

### Arrangement of Focus Detecting Areas

Referring now to FIG. 7, a description will be given of focus detecting areas, which are areas of the image sensor 122 from which a pair of signal sequences for detecting a phase difference is acquired. In one or more embodiments, the camera MPU 125 sets focus detecting areas. FIG. 7 illustrates an array diagram of focus detecting areas in one or more embodiments. A(n, m) and B(n, m) indicate the n-th focus detecting area in the x direction and the m-th focus detecting area in the y direction among a plurality of focus detecting areas (three in the x direction and three in the y direction, for a total of nine) which are set in an effective pixel area 300 of the image sensor 122. A signal sequence of a pixel pair which is pupil-divided in a horizontal direction is generated from a plurality of pixels included in the focus detecting area A(n, m). A signal sequence of a pixel pair which is pupil-divided in a vertical direction is generated from a plurality of pixels included in the focus detecting area B(n, m). I(n, m) indicates an index which displays a position of the focus detecting area A(n, m) or B(n, m) on the display unit 126. By arranging the focus detecting areas in this manner, the focus detection can be performed at the position of the index I(n, m) by using contrast information corresponding to both the horizontal and vertical directions of the object.

The nine focus detecting areas which are illustrated in FIG. 7 are merely an example, and the number, positions and sizes of the focus detecting areas are not limited. For example, one or more areas may be set as a focus detecting area within a predetermined range centered on a position specified by the user or the object position detected by the object detector 130. In acquiring a defocus map, which will be described later, one or more embodiments arrange focus detecting areas so as to obtain focus detection results with higher resolution. For example, a group of focus detection results acquired from totally 187 horizonal focus detecting areas arranged on the image sensor 122, horizontal 17 divisions and vertical 11 divisions, is arranged as a horizonal defocus map. In addition, for example, a group of focus detection results acquired from vertical focus detecting areas arranged on the image sensor 122 in a total of 35 points, divided into 7 horizontally and 5 vertically, is arranged as a vertical defocus map. The method of arranging the focus detecting areas for the horizonal focus detection and the focus detecting areas for the vertical focus detection for the object will be described in detail later.

### Imaging Processing

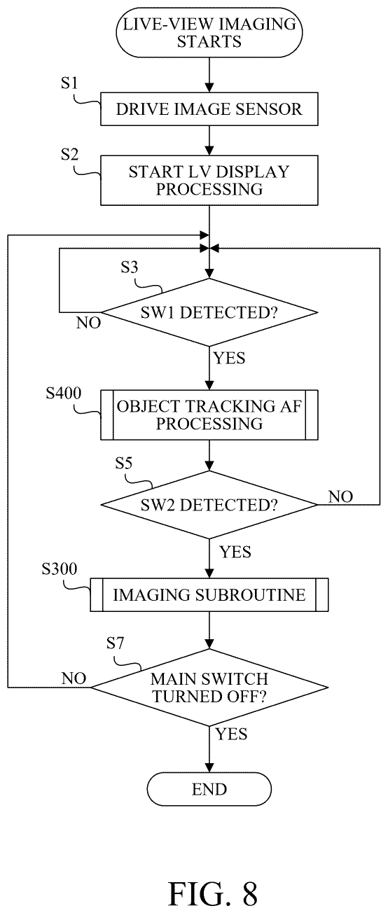

FIG. 8 illustrates a general flow of live-view imaging processing in one or more embodiments. More specifically, FIG. 8 illustrates the processing that causes the camera body 120 to perform a pre-imaging operation that displays a live-view image on the display unit 126 to an operation that captures a still image. The camera MPU 125, which is a computer, executes this processing according to a computer program. In the following description, S stands for the step.

In S1, the camera MPU 125 causes the image sensor drive circuit 123 to drive the image sensor 122 and acquires imaging data from the image sensor 122. Thereafter, the camera MPU 125 acquires first and second focus detecting signals from the plurality of first and second focus detecting pixels included in each of the focus detecting areas illustrated in FIG. 7 from the acquired imaging data. The camera MPU 125 also adds the first and second focus detecting signals of all effective pixels of the image sensor 122 to generate an imaging signal, and has the image processing circuit 124 perform the image processing for the imaging signal (imaging data) to acquire image data. In a case where the imaging pixels and the first and second focus detecting pixels are provided separately, the camera MPU 125 acquires the image data by performing interpolation processing for the focus detecting pixels.

Next, in S2, the camera MPU 125 causes the image processing circuit 124 to generate a live-view image from the image data acquired in S2, and causes the display unit 126 to display this image. The live-view image is a reduced image which matches a resolution of the display unit 126, and the user can adjust an imaging composition, an exposure condition, and the like while viewing this image. Therefore, the AE unit 131 and the camera MPU 125 perform an exposure adjustment based on a photometric value acquired from the image data, and display the image on the display unit 126. The exposure adjustment is achieved by properly adjusting an exposure time, opening and closing an aperture of an imaging lens, and controlling a gain of an output of the image sensor 122.

Next, in S3, the camera MPU 125 determines whether or not a switch Sw1, which instructs a start of an imaging preparation operation, has been turned on by half-pressing a release switch included in the operation switch 127. In a case where the switch Sw1 is not turned on, the camera MPU 125 repeats the determination in S3 in order to monitor a timing at which the switch Sw1 is turned on. On the other hand, in a case where the switch Sw1 is turned on, the camera MPU 125 proceeds to S400 and performs object tracking AF processing. Here, the camera MPU 125 performs processing such as detecting the object area from the acquired imaging signal and focus detecting signal, setting the focus detecting area, and predictive AF processing to suppress influence of a time lag between the focus detection processing and the imaging processing for a recorded image. Details will be given later.

In S5, the camera MPU 125 determines whether or not a switch Sw2, which instructs a start of an imaging operation, has been turned on by fully pressing the release switch. In a case where the switch Sw2 is not turned on, the camera MPU 125 returns to S3. On the other hand, in a case where the switch Sw2 is turned on, the flow proceeds to S300, where an imaging subroutine is executed. The imaging subroutine will be described in detail later.

In S7, the camera MPU 125 determines whether or not a main switch included in the operation switch 127 has been turned off. In a case where the main switch is turned off, the camera MPU 125 ends this processing, and in a case where the main switch is not turned off, the flow returns to S3.

In one or more embodiments, after it is detected in S3 that the switch Sw1 is turned on, the object detection processing and AF processing are performed, but the timing for performing these processes is not limited to this example. The object tracking AF processing performed in S400 before the switch Sw1 is turned on can eliminate the need for a preparatory operation by the photographer (user) before imaging.

### Imaging Subroutine

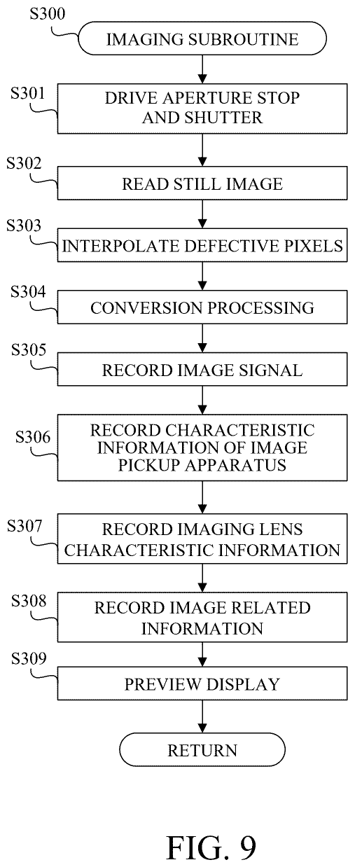

Next, the imaging subroutine executed by the camera MPU 125 in S300 of FIG. 8 will be described with reference to FIG. 9. FIG. 9 is a flowchart of the imaging subroutine.

In S301, the AE unit 131 performs exposure control processing and determines imaging conditions (a shutter speed, an aperture value (F-number), an imaging sensitivity, etc.). This exposure control processing can be performed using luminance information acquired from the image data of the live-view image. The camera MPU 125 then transmits the determined aperture value to the aperture drive circuit 115 to drive the aperture stop 102. The camera MPU 125 transmits the determined shutter speed to the shutter 133 to open the focal plane shutter. The camera MPU 125 causes the image sensor 122 to accumulate electric charges during the exposure period through the image sensor drive circuit 123.

In S302, the camera MPU 125 causes the image sensor drive circuit 123 to read out all pixels on the image sensor 122 for imaging signals of still image capturing. The camera MPU 125 causes the image sensor drive circuit 123 to read out one of the first and second focus detecting signals from the focus detecting area (in-focus target area) on the image sensor 122. By subtracting one of the first and second focus detecting signals from the imaging signal, the other focus detecting signal can be acquired.

In S303, the camera MPU 125 causes the image processing circuit 124 to perform defective pixel correction processing for the imaging data which was read out in S302 and A/D converted.

In S304, the camera MPU 125 causes the image processing circuit 124 to perform image processing and encoding processing for the imaging data that has received the defective pixel correction processing. The image processing includes demosaic (color interpolation) processing, white balance processing, gamma correction (tone correction) processing, color conversion processing, and edge enhancement processing.

In S305, the camera MPU 125 records, as an image data file, in the memory 128, still image data as image data acquired by performing image processing and encoding processing in S304, and one of the focus detecting signals read out in S302.

In S306, the camera MPU 125 records camera characteristic information as characteristic information on the camera body 120 in the lens memory 118 and in a memory within the camera MPU 125, in association with the still image data recorded in S305. The camera characteristic information includes, for example, the following information:
imaging condition (an aperture value, a shutter speed, an imaging sensitivity, etc.),
information on the image processing performed by the image processing circuit 124
information on a light receiving sensitivity distribution of the imaging pixels and focus detecting pixels on the image sensor 122,
information on vignetting of an imaging light beam in the camera body 120,
information on a distance from an attachment surface of the imaging optical system in the camera body 120 to the image sensor 122, and
information on manufacturing errors of the camera body 120.

Information on the light receiving sensitivity distribution of the imaging pixels and focus detecting pixels (simply referred to as light receiving sensitivity distribution information hereinafter) is information on the sensitivity of the image sensor 122 depending on a distance (position) on the optical axis from the image sensor 122. The light receiving sensitivity distribution information depends on the microlens 305 and the photoelectric converters 301 and 302, and therefore may be information relating to these. The light receiving sensitivity distribution information may be information on a change in sensitivity with respect to an incident angle of light.

In S307, the camera MPU 125 records lens characteristic information as characteristic information on the imaging optical system in the memory 128 and in the memory within the camera MPU 125, in association with the still image data recorded in S305. The lens characteristic information may include information on an exit pupil, information on a frame such as a lens barrel which blocks a light beam, information on a focal length and an F-number during imaging, information on an aberration of the imaging optical system, information on a manufacturing error of the imaging optical system, or information on a position of the focus lens 104 during imaging (object distance).

In S308, the camera MPU 125 records image related information, which is information on the still image data, in the memory 128 and in the memory within the camera MPU 125. The image related information includes, for example, information on a focus detection operation before image capturing, information on a movement of the object, and information on a focus detection accuracy.

In S309, the camera MPU 125 performs a preview display of the captured image on the display unit 126. This allows the user to easily check the captured image.

When the processing of S309 ends, the camera MPU 125 ends this imaging subroutine and proceeds to S7 of FIG. 8.

### Subroutine of Object Tracking AF Processing

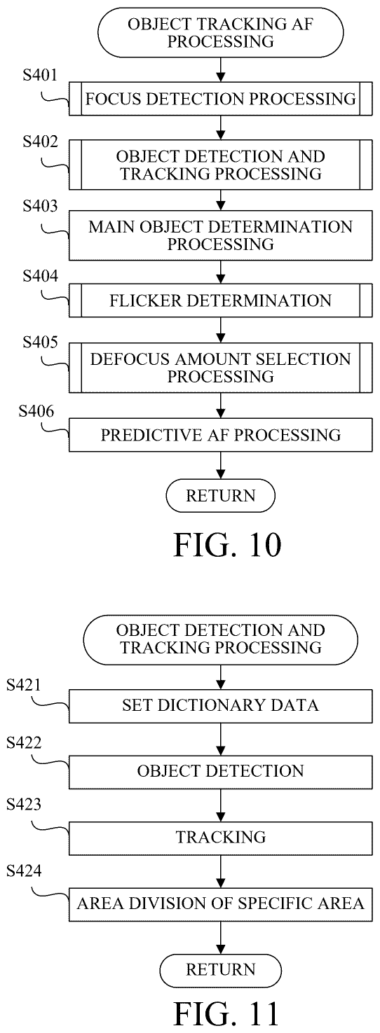

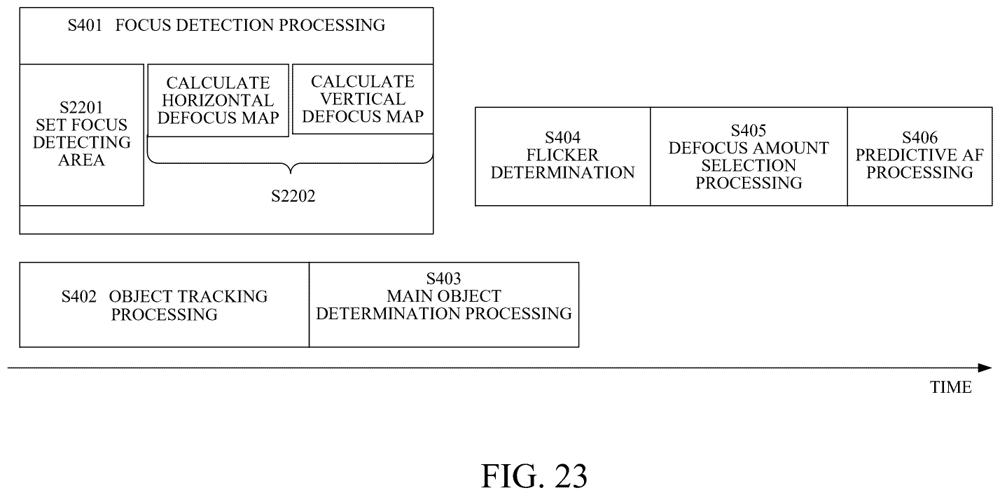

A subroutine of the object tracking AF processing executed by the camera MPU 125 in S400 of FIG. 8 will be described with reference to FIG. 10. FIG. 10 is a flowchart of the object tracking AF processing subroutine. The chronological order in which steps S401 to S406 in this flow are executed will be described later with reference to FIG. 23.

In S401, the camera MPU 125 and the phase-difference AF unit 129 perform focus detection processing by using the first and second focus detecting signals acquired in each of the plurality of focus detecting areas acquired in S1. Details of this will be described later.

In S402, the camera MPU 125 performs object detection processing and tracking processing. The object detection processing is executed by the object detector 130. Depending on a state of the acquired image, an object may not be detectable. In this case, the tracking processing using other means such as template matching is performed to estimate a position of the object. Details of this will be described later.

In S403, the camera MPU 125 performs main object determination processing. The method for determining a main object is determined according to a priority order based on a predetermined criterion. For example, the closer a position of an object detecting area is to a central image height, the higher the priority is set, and in a case where the positions are the same (the distances from the central image height are the same), the larger the size is, the higher the priority is set. Also, a configuration may be adopted in which a defocus map is used to select a portion of a particular type of object (person) that the user often wishes to focus on.

In S404, the camera MPU 125 and the phase-difference AF unit 129 determine whether or not flicker occurs in each focus detecting area (flicker determination). In the vertical focus detection, the focus detection accuracy may decrease due to the influence of flicker, so in a case where the influence of flicker is expected to be large, a result of the vertical focus detection is not used. The method of detecting flicker and the determination of whether or not the vertical focus detection can be used will be described in detail later.

Next, in S405, the camera MPU 125 and the phase-difference AF unit 129 perform defocus amount selection processing. Based on the object information acquired in S402 and the flicker determination result acquired in S404, a defocus amount, which is the focus detection result, is selected using the focus detection results acquired from the arranged horizonal defocus map and vertical defocus map. Details of this will be described later.

In S406, the camera MPU 125 performs the predictive AF processing using the defocus amount acquired in S405 and a plurality of defocus amounts which are time-series data on the timings at which past focus detections were performed. This is necessary processing when there is a time lag between the timing of focus detection and the timing of exposure for the captured image. More specifically, this is processing for performing AF control by predicting a position of the object in the optical axis direction at the timing of exposure for the captured image, which is a predetermined time after the timing of focus detection. An image plane position of an object is predicted by performing multivariate analysis (for example, the least squares method) using historical data of the image plane positions of the object in the past and time, to obtain an equation for a prediction curve. By substituting the time of exposure for the captured image into the equation for the acquired prediction curve, the predicted image plane position of the object can be calculated. Not only the optical axis direction but also three-dimensional positions may be predicted. Assume that the screen is represented as XY and the optical axis direction is represented as the Z direction, forming vectors in the XYZ directions. Then, an object position at an exposure timing for a captured image may be predicted from the XY position of the object acquired by the object detection and tracking processing in S402 and the time-series data of the Z direction position from the defocus amount acquired in S405. The prediction may be performed from time-series data on joint positions of a human object. The above prediction enables each position to be estimated even if a ball or person is hidden during imaging, or even if some of the person's joint positions become invisible. The object to be predicted is not only the main object, but also a plurality of detected objects. By performing the predictive AF processing for a plurality of objects, when the main object is switched, it is not necessary to re-accumulate the history of a defocus amount of a new main object, and the predictive AF can be continued without time loss.

In S406, the camera MPU 125 calculates a drive amount of the focus lens 104 using the predictive AF processing result. According to a focus drive command from the camera MPU 125, the lens MPU 117 drives the focus actuator 113 using the focus drive circuit 116 to move the focus lens 104 in the optical axis direction, thereby performing focusing processing.

When the processing of S406 ends, the camera MPU 125 ends the subroutine of this object tracking AF processing, and proceeds to S5 in FIG. 8.

Referring now to FIG. 23, a description will be given of the chronological execution order of steps S401 to S406. FIG. 23 illustrates the chronological execution order of the focus detection processing. One or more embodiments simultaneously execute the focus detection processing in S401 and the object tracking processing in S402. S401 is executed by the camera MPU 125 and the phase-difference AF unit 129, and S402 is executed by the object detector 130. S402 may be executed after S401 is completed. In the focus detection processing in S401, S2202 in FIG. 22 is performed after S2201 in FIG. 22 is completed. One or more embodiments calculate the vertical defocus map after the horizonal defocus map is calculated. The vertical defocus map may be calculated first, and then the horizonal defocus map may be calculated.

The main object determination processing in S403 is executed after the completion of S402. In S403, the defocus map is used, but in one or more embodiments, since calculation of the vertical defocus map has not been completed, the horizonal defocus map is used. S403 may be executed after S401 is completed.

In one or more embodiments, S404 is executed after steps S401 and S403 are completed.

In one or more embodiments, S405 is executed after steps S403 and S404 are completed.

In one or more embodiments, S406 is executed after the completion of S405.

### Subroutine of Focus Detection Processing

A subroutine of the focus detection processing executed by the camera MPU 125 in S401 of FIG. 10 will be described with reference to FIG. 22. FIG. 22 is a flowchart of focus detection processing.

In S2201, the camera MPU 125 sets a focus detecting area. One or more embodiments set totally 187 horizonal focus detecting areas on the image sensor 122, horizontal 17 divisions and vertical 11 divisions. The camera MPU 125 sets totally 35 vertical focus detecting areas on the image sensor 122, horizontal 7 divisions and vertical 5 divisions. The center of the focus detecting area is set based on either the AF area set via the operation switch 127, the position of the object detected and tracked in S402, or the position of the main object determined in S403. In one or more embodiments, a group of focus detection results acquired from the horizonal focus detecting areas will be referred to as a horizonal defocus map, and a group of focus detection results acquired from the vertical focus detecting area will be referred to as a vertical defocus map.

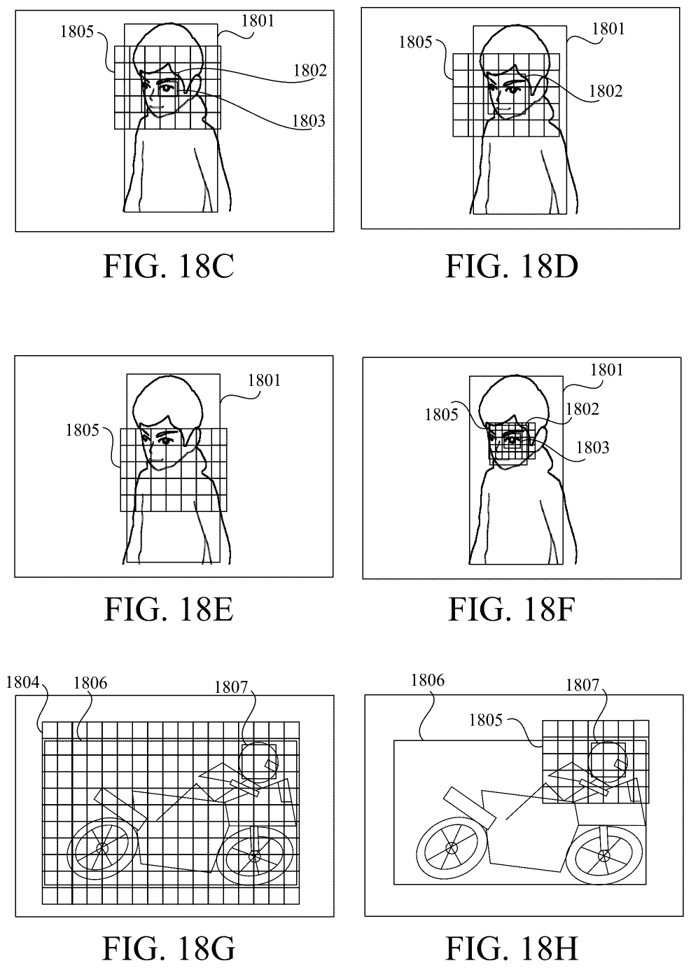

A method for setting a defocus map, which is a group of horizonal and vertical focus detecting areas, will be described with reference to FIGS. 18A, 18B, 18C, 18D, 18E, 18F, 18G, and 18H. FIGS. 18A, 18B, 18C, 18D, 18E, 18F, 18G, and 18H illustrate a setting method of the defocus map. FIG. 18A illustrates an object area detected by the object detection processing in a case where the object is a person. Reference numeral 1801 denotes an upper body detecting area, reference numeral 1802 denotes a face detecting area, and reference numeral 1803 denotes an eye detecting area.

The arrangement of the horizonal defocus map, which is a horizonal focus detecting area group, will be described. FIG. 18B illustrates the horizonal defocus map during pupil detection, and reference numeral 1804 denotes the horizonal defocus map. The horizonal defocus map is arranged relative to the center of the upper body detecting area so as to encompass the object. Thereby, the object can fall within the defocus map even when the object as a person is moving or during framing with the camera.

Next, the arrangement of the vertical defocus map, which is a vertical focus detecting result group, will be described. FIG. 18C illustrates the vertical defocus map when a face is detected, and reference numeral 1805 denotes the vertical defocus map. One or more embodiments assume that the vertical defocus map has a smaller area than that of the horizonal defocus map due to the constraints of calculation time. Since the horizonal defocus map can encompass the object, the vertical defocus map is set based on the area on which the user wishes to focus on. In a case of a person, the area on which the user (photographer) wishes to focus on is often the pupil, so in FIG. 18C, the vertical defocus map is set with the pupil detecting area 1803 at the center. Thereby, in a defocus amount selection processing described later, the user can select the defocus amount by using both the horizonal defocus map and the vertical defocus map in the area where the user wishes to focus on.

In a case where the pupil has not been detected, the vertical defocus map is set with the face detecting area 1802 at the center, as illustrated in FIG. 18D. In a case where the face has not been detected, the vertical defocus map is set with the upper body detecting area 1801 at the center, as illustrated in FIG. 18E.

The horizonal defocus map and the vertical defocus map may be set so that the center position and area of each focus detecting area are similar. Thereby, the focus detection can be performed using signals from the same focus detecting area, and thus in the defocus amount selection processing described below, the horizontal defocus amount and the vertical defocus amount can be used together without distinction.

FIG. 18F illustrates a case where the area of the vertical defocus map is made smaller and each focus detecting area is made smaller. Densely arranging the vertical defocus map in the face detecting area can achieve defocus amount selection processing described later using a greater number of defocus amounts.

FIG. 18G illustrates an example in which the object is a motorcycle. Reference numeral 1806 denotes the entire detecting area of the motorcycle, and reference numeral 1807 denotes a local detecting area which is the area of a helmet of the motorcycle. Similarly to the case of the person, the horizonal defocus map is placed to encompass the entire detecting area.

FIG. 18H illustrates the setting of the vertical defocus map when the motorcycle is locally detected. The vertical defocus map is not placed at the center of the local detecting area 1807, but is placed in an area in which the position and size of the horizonal defocus map and each focus detecting area can be aligned and which encompasses the local detecting area. Thereby, as described above, the defocus amount is the result of horizonal focus detection and vertical focus detection using signals from the same focus detecting area. Therefore, in the defocus amount selection processing described later, the horizonal defocus amount and the vertical defocus amount can be used together without distinction.

In S2202, the camera MPU 125 acquires a defocus map. For the focus detecting area set in S2201, the phase-difference AF unit 129 calculates an image shift amount between the first and second focus detecting signals acquired in each of the plurality of focus detecting areas acquired in S2. The phase-difference AF unit 129 then calculates the defocus amount and reliability for each focus detecting area from the image shift amount.

### Subroutine of Object Detection and Tracking Processing

A subroutine of the object detection and tracking processing executed by the camera MPU 125 in S402 of FIG. 10 will be described with reference to FIG. 11. FIG. 11 is a flowchart of the object detection and tracking processing.

In S421, the camera MPU 125 sets dictionary data according to the type of an object to be detected from the image data acquired in S1. Based on the object priority and the settings of the image pickup apparatus which have been previously set, dictionary data to be used in this processing is selected from a plurality of dictionary data stored in the dictionary data memory. For example, the plurality of dictionary data are stored by classifying objects into categories such as “person,” “vehicle,” and “animal.” In one or more embodiments, the dictionary data to be selected may be one or more. In the case of single dictionary data, it becomes possible to repeatedly detect an object that can be detected by the single dictionary data, at a high frequency. On the other hand, in a case where the plurality of dictionary data are selected, the dictionary data can be set sequentially according to the priority of the detected object, thereby making it possible to detect the objects one by one.

In S422, the object detector 130 performs the object detection using the image data read out in S1 as an input image and the dictionary data set in S421. At this time, the object detector 130 outputs information such as the position, size, and reliability of the detected object. At this time, the camera MPU 125 may cause the display unit 126 to display the above information output by the object detector 130. In S422, a plurality of areas of the object are detected hierarchically from the image data. For example, in a case where “person” or “animal” is set as dictionary data, a plurality of organs such as the “whole body” area, the “face” area, and the “eye” area are detected. While local areas such as a person's eye and face are areas as an object to be focused on and exposed, they may not be detectable due to surrounding obstacles or a direction of the face. Even in such a case, the object can be robustly detected continuously by detecting the whole body, and therefore the object is detected hierarchically. Similarly, in a case where a “vehicle” such as a motorcycle is set as dictionary data, the driver, the whole vehicle including the vehicle body, and the helmet (head) as a local area are detected hierarchically.

In S423, the camera MPU 125 performs known template matching processing using the object detecting area acquired in S422 as a template. Using the plurality of images acquired in S1, a similar area is searched for in the image acquired immediately before, using the object detecting area acquired in the previous image as a template. As is well known, any information may be used for template matching, such as luminance information, color histogram information, or feature point information such as corners and edges. There are various possible matching methods and template updating methods, and any of them may be used. The tracking processing performed in S423 is performed in order to achieve stable object detection and tracking processing by detecting an area similar to the past object detection data from the image data acquired immediately before in a case where an object is not detected in S422.

Next, in S424, the object detector 130 performs an area division on a specific area for the detected object area into specific areas. The specific area refers to a part or the whole of the detected object area. For example, in a case where a person or an animal is detected, it is the area of the person's head, and in a case where a vehicle is detected, it is the area of the helmet. Unlike object detection, in which the size and position of an object are acquired using the size and coordinates of a rectangular area, the area division allows the detection result to be acquired as a high-resolution distribution of the specific area. As a method for the area division, any method (for example, the method disclosed in Chen et.al, DeepLab: Semantic Image Segmentation with Deep Convolutional Nets, Atrous Convolution, and Fully Connected CRFs, arXiv, 2016) can be applied. The object detector 130 uses a deep-trained CNN to infer the likelihood (probability) of each pixel area being the specific area. However, the object detector 130 may infer the likelihood of the specific area using a trained model that has been machine-learned using an arbitrary machine learning algorithm, or may determine the likelihood of the specific area based on a rule base. In a case where a CNN is used to infer the likelihood of the specific area, the CNN performs deep learning using the specific area as a positive example and areas other than the specific area as negative examples. As a result, the CNN outputs the likelihood of the specific area in each pixel area as an inference result.

### Calculation Method of Specific Area

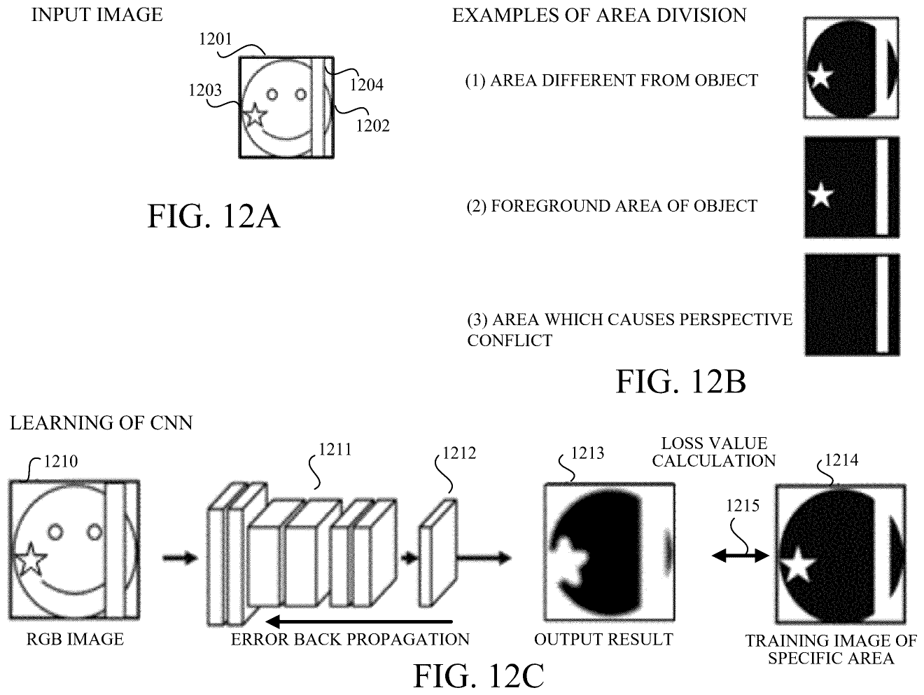

FIGS. 12A, 12B, and 12C illustrate an example of a convolutional neural network (CNN) which infers the likelihood of the specific area. FIG. 12A illustrates an example of an object area of an input image to be input to the CNN. The object area 1201 is detected from an image by the object detection described above. The object area 1201 includes a face area 1202 which is a target of the object detection. The face area 1202 in FIG. 12A includes two occluded areas (occluded areas 1203 and 1204). The occluded area 1203 is an area with no depth difference from the face area, and the occluded area 1204 is an area with a depth difference. The occluded area is also called an occlusion. In one or more embodiments, the face area 1202 excluding the occluded areas 1203 and 1204 is detected as the specific area.

FIG. 12B illustrates an example definition of specific area information. Each of images (1) to (3) in FIG. 12B is divided into black and white areas, where the black area indicates a positive example and the white area indicates a negative example. In FIG. 12B, the specific area information acquired by image division of the object area is an image that is assumed to be a candidate for training data that is used for deep learning of the CNN. Hereinafter, which of the specific area information in FIG. 12B is used as the training data in one or more embodiments will be described.

Image (1) in FIG. 12B illustrates an example of occlusion information in a case where the area is divided into an object area (face area) and a non-object area, the object area is treated as a positive example, and the areas other than the object area, such as the background and occluded areas, are treated as negative examples. Image (2) in FIG. 12B illustrates an example of occlusion information in a case where the area is divided into a foreground occluded area for the object and other areas, the foreground occluded area is treated as a negative example, and the areas other than the foreground occluded area relative to the object is treated as positive examples. Image (3) in FIG. 12B illustrates an example of occlusion information in a case where the area is divided into an occluded area which causes perspective conflict and other areas, and the occluded area which causes perspective conflict is treated as a negative example and the areas other than the occluded area which causes perspective conflict are treated as positive examples.

As illustrated in image (1) in FIG. 12B, a person's face in the image has a characteristic visibility pattern and a small pattern variance, so the area can be divided with high accuracy. For example, the occlusion information on image (1) in FIG. 12B is suitable as training data in the learning processing for generating the CNN that detects a person as an object. From the viewpoint of detection accuracy, the occlusion information on image (1) in FIG. 12B is more suitable than the occlusion information on image (3) in FIG. 12B. However, an image like image (3) in FIG. 12B is suitable as training data for the learning processing for generating the CNN that detects an occluded area, which causes perspective conflict. A pair of parallax images for the focus detection may be used as training data in the learning processing for generating the CNN that detects an occluded area which causes perspective conflict. The occlusion information is not limited to the above example, and may be generated based on an arbitrary method for dividing an area into an occluded area and areas other than the occluded area. One or more embodiments emphasize the accuracy of the detecting area, and performs the learning processing using the information on image (1) in FIG. 12B, but may perform learning using other information.

FIG. 12C illustrates a flow of deep learning of the CNN. In one or more embodiments, an RGB image is used as the input image 1210 for learning. As a training image (teacher image), a training image 1214 (training image of specific area information) as illustrated in FIG. 12C is used. The training image 1214 is an image of face area information excluding the occlusion information and background information in FIG. 12B.

The input image 1210 for training is input to a neural network system 1211 (CNN). The neural network system 1211 can employ, for example, a layered structure in which convolutional layers and pooling layers are alternately stacked between an input layer and an output layer, and a multilayer structure in which a fully-connected layer is connected downstream of the layered structure. A score map that indicates the likelihood of a specific area in the input image is output from an output layer 1212 in FIG. 12C. The score map is output in the form of an output result 1213.

In deep learning of the CNN, an error between the output result 1213 and the training image 1214 is calculated as a loss value 1215. The loss value 1215 is calculated using a method such as cross entropy or squared error. Then, coefficient parameters such as the weights and biases of each node of the neural network system 1211 are adjusted so that the loss value 1215 gradually decreases. By performing sufficient deep learning of the CNN using many learning input images 1210, the neural network system 1211 will be able to output a more accurate output result 1213 when an unknown input image is input. In other words, when an unknown input image is input, the neural network system 1211 (CNN) outputs specific area information acquired through the area division of an occluded area and areas other than the occluded area with high accuracy as the output result 1213. Creating training data which identifies an occluded area (overlapping object area) requires a lot of work. Thus, it is conceivable to create training data using CG or using image combination in which an object image is cut out and superimposed.

As described above, this example has been described in which the image (1) in FIG. 12B is applied as the training image 1214, in which the face area, excluding the occluded area and background area, is the specific area. Even if an image such as image (2) or (3) in FIG. 12B is used as the training image 1214, when an unknown input image is input to the CNN, the CNN can infer an area which causes perspective conflict.

An arbitrary method other than the CNN can be applied to detect a specific area. For example, the detection of the specific area may be achieved by a rule-based approach. A trained model which has been machine-learned by an arbitrary method other than a deep-learned CNN may be used to detect the specific area. For example, occluded areas may be detected using a trained model which has been machine-learned by using any machine learning algorithm, such as a support vector machine or logistic regression. This is similar to object detection.

One or more embodiments detect the specific area for all detected objects, but can reduce a calculation amount by detecting the specific area only for the main object after the main object determination processing in S403.

When the processing of S424 is completed, the camera MPU 125 ends the object detection and tracking processing subroutine, and proceeds to S404 in FIG. 11.

### Subroutine of Flicker Determination

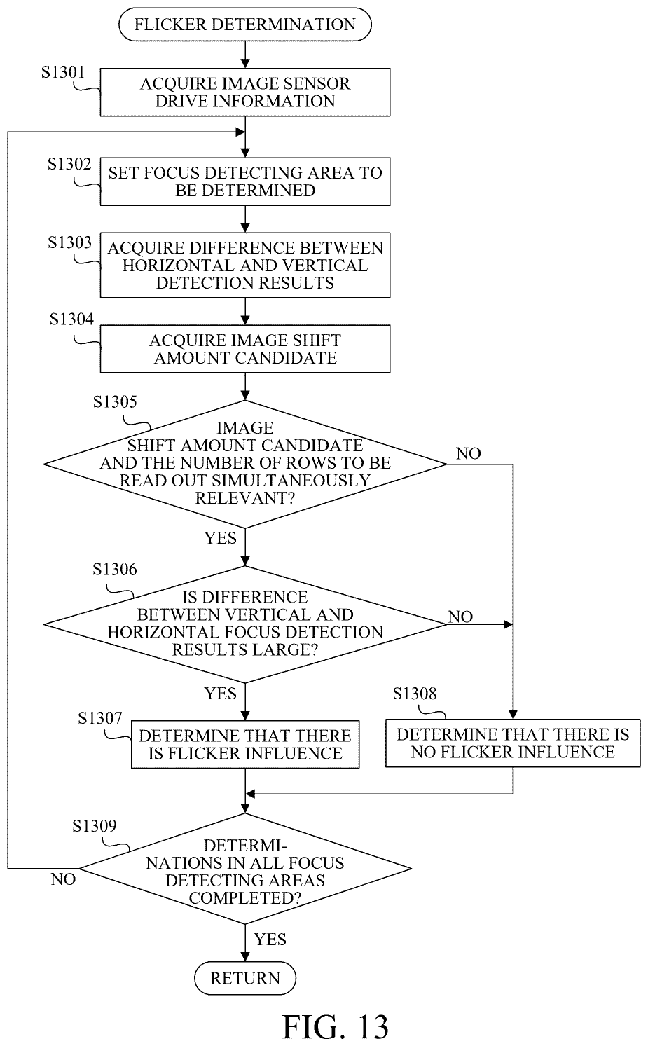

Next, a subroutine of the flicker determination executed by the camera MPU 125 in S404 of FIG. 10 will be described with reference to FIG. 13. FIG. 13 is a flowchart of the flicker determination.

In S1301, the camera MPU 125 acquires information on the driving of the image sensor 122 performed in S1. The image sensor 122 according to one or more embodiments selects from a variety of drive methods according to the luminance of the imaging environment and whether the recorded image is a still image or a moving image. In order to read out a signal on the screen within the time permitted by a frame rate (a drive rate of the image sensor) which is set based on the luminance of the imaging environment and the user's setting, the rows to be read out are thinned out or a signal from a plurality of rows are read simultaneously. In S1301, regarding the driving of the image sensor, information on a vertical focus detection result (image shift amount) is acquired, which occurs when flicker occurs, which is determined from the number of rows to be thinned out and the number of rows being simultaneously read out. One or more embodiments determine whether flicker has occurred in the imaging environment using the degree of coincidence between the acquired information and the calculation result by the phase-difference AF unit 129 as the image shift amount in the actual vertical focus detection. Details will be described later.

In S1302, the camera MPU 125 sets a focus detecting area for performing the flicker determination in the defocus map calculated in S401 of FIG. 10. One or more embodiments sequentially determine 24 areas that constitute the vertical defocus map.

In S1303, the camera MPU 125 acquires the horizonal focus detection result and the vertical focus detection result of the focus detecting area set in S1302, and calculates a difference between them. This processing is performed because in a case where the vertical focus detection result contains an error due to the influence of flicker, the difference between the vertical and horizonal focus detection results may increase.

In S1304, the camera MPU 125 acquires an image shift amount candidate in the vertical focus detection. In order to explain the image shift amount candidate, the correlation calculation for performing the focus detection in S401 will be described.

In one or more embodiments, a pair of signals used for the vertical focus detection will be referred to as an A-image signal and a B-image signal. The first, second, etc. outputs of the A-image signal in each row within the focus detecting area will be referred to as A(1), A(2), etc., and similarly, the first, second, etc. outputs of the B-image signal will be referred to as B(1), B(2), etc. Thus, 300 A-image (B-image) signals generated in sequence are concatenated to generate a pair of image signals. In the correlation calculation, a correlation amount is calculated while the positions of the paired image signals are shifted relative to each other, and a shift amount at a position where the correlation is highest (the shape of the paired image signals has the highest degree of agreement) is detected as an image shift amount. For example, correlation amount COR(h) can be calculated by the following Equation (1):

$$COR ( h ) = {\sum }_{j = 1}^{W 1} \vert A ( j + hmax - h ) - B ( j + hmax + h ) \vert ( - hmax \leq h \leq hmax ) \qquad ( 1 )$$

In equation (1), W1 corresponds to the number of data within the field, and hmax corresponds to the number of shift data. After calculating the correlation amount COR(h) for each shift amount h, the phase-difference AF unit 129 calculates the shift amount h that maximizes the correlation between the A-image and the B-image, i.e., the value of the shift amount h that minimizes the correlation amount COR(h). The shift amount h that is used in calculating the correlation amount COR(h) is an integer, but in a case where the shift amount h that minimizes the correlation amount COR(h) is calculated, in order to improve the accuracy of the defocus amount, the interpolation processing or the like is performed to determine a value (real value) in sub-pixel units.

One or more embodiments calculate the shift amount at which the sign of the difference value of the correlation amount COR changes as the shift amount h (sub-pixel unit) that minimizes the correlation amount COR(h).

First, the phase-difference AF unit 129 calculates difference value DCOR between correlation amounts according to the following equation (2):

$$DCOR ( 2 \times h ) = C O R ( h + 1 ) - C O R ( h - 1 ) \qquad ( 2 )$$

Then, using the difference value DCOR between correlation amounts, the phase-difference AF unit 129 obtains a shift amount dh1 at which the sign of the difference amount changes. Where h1 is a value of h just before the sign of the difference amount changes, and h2 (h2=h1+1) is a value of h after the sign changes, the phase-difference AF unit 129 calculates the shift amount dh1 according to the following equation (3):

$$dh 1 = ( h 1 + \vert DCOR 1 ( h 1 ) \vert / \vert DCOR 1 ( h 1 ) - D C O R 1 ( h 2 ) \vert ) \times 2 \qquad ( 3 )$$

Thus, the phase-difference AF unit 129 calculates the shift amount dh1 that maximizes the correlation between the A-image and B-image of the first signal in sub-pixel units, and then ends the processing. The method for calculating the shift amount (phase difference) between two one-dimensional image signals is not limited to the method described here, and an arbitrary known method can be used. As a result of performing the above correlation calculation, a plurality of shift amounts which change the sign of the difference value of the correlation amount COR may be calculated. In the normal focus detection, a shift amount that maximizes the difference value is selected and the focus detection is performed, but in S1304, a plurality of calculated shift amounts are acquired as image shift amount candidates. A method for using the image shift amount candidates will be described in detail later.

Next, in S1305, the camera MPU 125 determines whether there is a correlation between the image shift amount candidate acquired in S1304 and the information on the result of the vertical focus detection (image shift amount) that occurs when flicker has occurred regarding the drive method of the image sensor acquired in S1301. In a case where the image shift amount candidate value acquired in S1304 or its difference is close to the image shift amount acquired in S1301 within a predetermined value, the flow proceeds to S1306; otherwise, the flow proceeds to S1308.

In S1306, the camera MPU 125 determines the magnitude of the difference between the vertical and horizontal focus detection results acquired in S1303. In a case where the difference is large, the flow proceeds to S1307, and in a case where the difference is small, the flow proceeds to S1308.

In S1307, since the set focus detecting area has an error in the vertical focus detection result due to flicker, the camera MPU 125 determines that there is flicker influence.

In S1308, the camera MPU 125 determines that the set focus detecting area is less affected by flicker on the vertical focus detection result.

After S1307 or S1308 ends, the flow proceeds to S1309, where the camera MPU 125 determines whether the flicker determination has been completed in all focus detecting areas. In a case where the flicker determination has not been completed, the flow returns to S1302 and the above processing is repeated. In a case where the flicker determination has been completed, the processing of this subroutine is completed, and the flow proceeds to S405.

### Drive Method of Image Sensor and Flicker Influence on Vertical Focus Detection

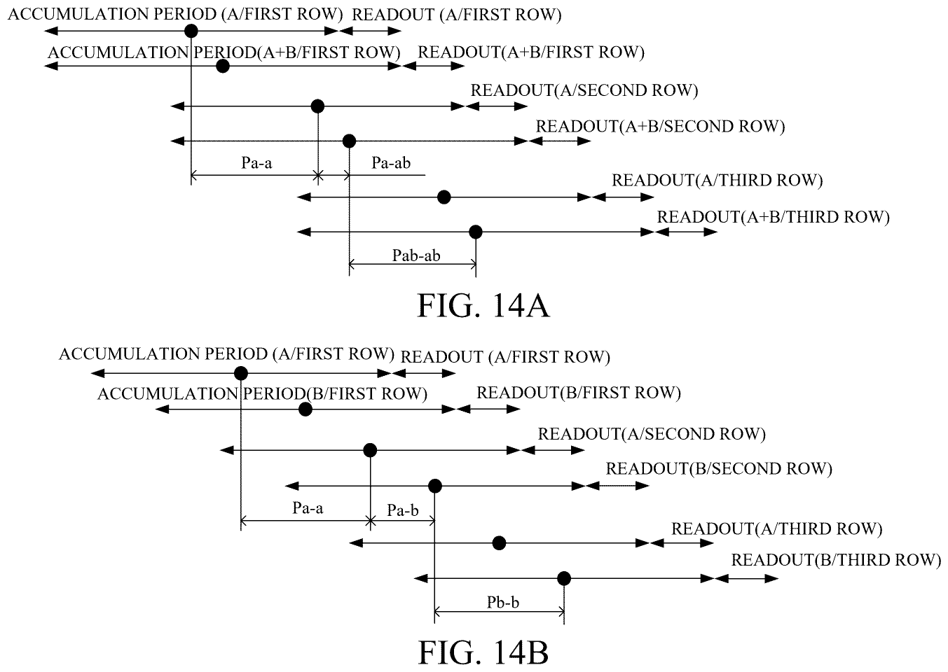

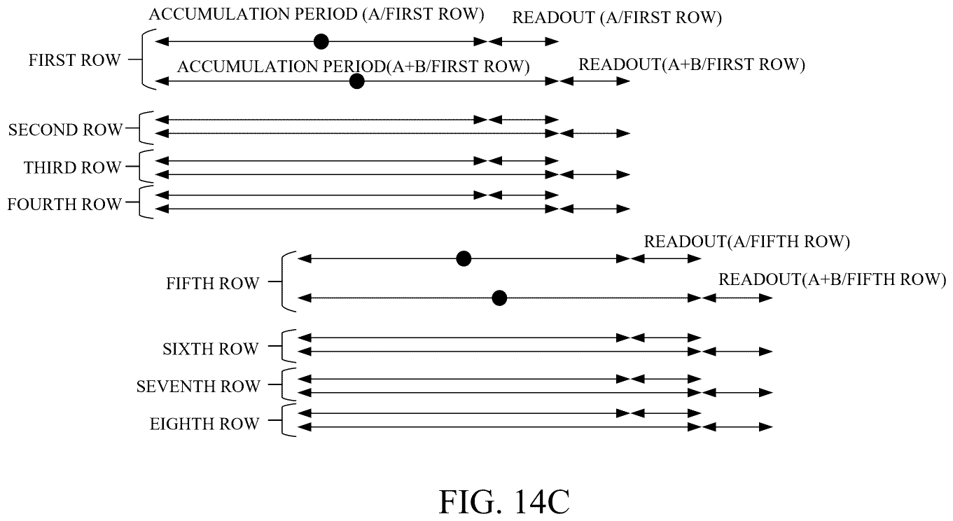

Referring to FIG. 14A to FIG. 16D, a description will be given of a mechanism by which an error occurs in the vertical focus detection due to flicker along with the drive method of the image sensor 122.

Flicker, which occurs in illumination, digital signage, etc., is a phenomenon in which light blinking repeats over time at an invisible frequency. On the other hand, an image sensor 122 using the slit rolling method accumulates and reads out signals from each row sequentially over time. In a case where a slit rolling type image sensor 122 is sequentially exposed in an environment having flicker (flicker environment), the signal of each row increases or decreases due to the flicker influence caused by a difference in accumulation time of each row. One or more embodiments also read the focus detecting signals for each row, but the paired signals that are used for the horizonal focus detection use signals from the same row, and are therefore affected by flicker to the same extent, so the influence on the focus detection results is small. On the other hand, the pair of signals that are used for the vertical focus detection are subject to flicker within the pair of signal sequence because the signal sequence forming direction coincides with the readout direction of the slit rolling method.

FIGS. 14A, 14B, and 14C explain the flicker influence on a pair of signals in the vertical focus detection. FIG. 14A illustrates the passage of time horizontally from left to right, and illustrates the timing of accumulation and readout of a focus detecting signal (A-image) and an imaging signal ((A+B)-image) for each row of the image sensor 122 on the time axis. As described with reference to FIG. 2B, the A-signal and the (A+B)-signal are output for each row, and the diagram in the upper two rows in FIG. 14A illustrates the accumulation period and the readout period. After the PDA 211 and the PDB 212 are reset, accumulation of the A-signal and the (A+B)-signal is started, and as soon as accumulation of the A-signal is completed, the voltage is read out. After the readout of the A-signal is completed, the accumulation of the (A+B)-signal is completed and the voltage is read out. Similarly, the signal of the second row is read out. The time difference between the accumulation period of the A-signal in the first row and the accumulation period of the A-signal in the second row is considered to be a difference in the centers of the accumulation periods, so the interval is Pa-a. The interval between the accumulation period of the (A+B)-signal in the first row and the accumulation period of the (A+B)-signal in the second row is Pab-ab. As described above, in the flicker environment, luminance changes over time, and thus the signal outputs of the first and second rows change over time for Pa-a and Pab-ab. A difference between the accumulation periods of the A-signal and the (A+B)-signal is indicated as Pa-ab. In the flicker environment, the A-signal and the (A+B)-signal have a difference of Pa-ab in the accumulation period for each row. Due to the difference of Pa-ab, the waveforms of the A-signal and the (A+B)-signal have an image shift amount due to the flicker influence. Due to the difference in the accumulation period between the A-signal and the (A+B)-signal, the waveform of the B-signal is shifted horizontally from the waveform of the A-signal by Pa-ab/Pa-a pixel. For example, as illustrated in FIG. 14A, the accumulation start time for each row is shifted by a time corresponding to the sum of the readout periods of the A-signal and the (A+B)-signal. In a case where the readout periods of the A-signal and the (A+B)-signal are equal, the waveform of the B-signal is shifted horizontally from the waveform of the A-signal by Pa-ab/Pa-a pixel=¼ pixel.

FIG. 14B illustrates a case where the control regarding the exposure of each row is different from that of FIG. 14A, and the A-signal and the B-signal are read out in each row. This illustrates a case where the accumulation start times of the A-signal and the B-signal in the first row are shifted by the readout period of the A-signal. As in FIG. 14A, due to a difference in accumulation period between the A-signal and the (A+B)-signal, the waveform of the B-signal is shifted horizontally from the waveform of the A-signal by Pa-ab/Pa-a pixel. For example, suppose that the accumulation start times for the A-signal on the first row, the B-signal on the first row, the A-signal on the second row, etc. are shifted by the times corresponding to the readout period of the A-signal on the first row, the readout period of the B-signal on the first row, the readout period of the A-signal on the second row, etc. In a case where the readout periods of the A-signal and the B-signal are equal, the waveform of the B-signal is shifted horizontally from the waveform of the A-signal by Pa-ab/Pa-a pixels=½ pixel.

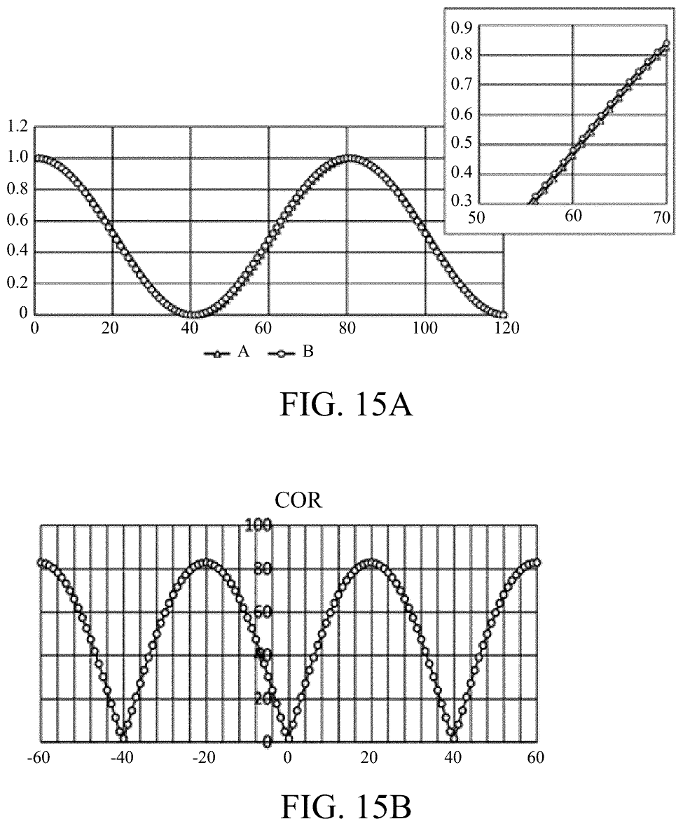

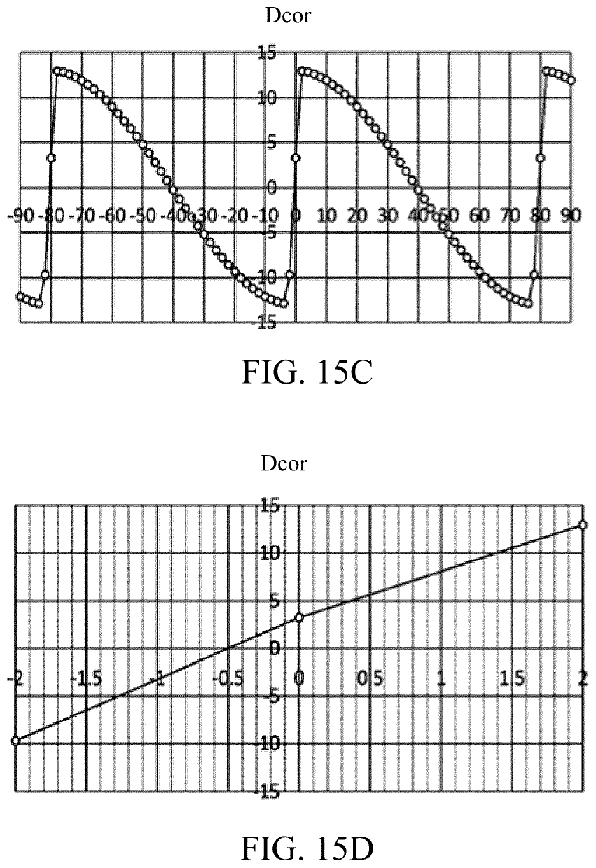

FIGS. 15A, 15B, 15C, and 15D illustrate waveforms in the flicker environment. FIG. 15A illustrates the A-signal and the B-signal corresponding to the case of FIG. 14B. A horizontal axis (abscissa) indicates a pixel number, and a vertical axis (ordinate) indicates a signal output normalized by the maximum value. The rippling output of each pixel indicates flicker over time. A partially enlarged view is illustrated in the upper right corner of FIG. 15A, and it can be understood that the waveforms of the A-signal and the B-signal are slightly shifted. As described in S1304, FIG. 15B illustrates a result of calculating a correlation amount. A horizontal axis indicates a positional shift amount between the A-signal and the B-signal, and a vertical axis indicates a correlation amount which indicates the magnitude of correlation. In FIG. 15B, it can be understood that the correlation amount has a minimum value when the shift amount is in the vicinity of ±40 pixels and 0 pixel. FIG. 15C illustrates a calculated difference value DCOR between correlation amounts. A horizontal axis indicates a shift amount, and a vertical axis indicates a difference value between correlation amounts. Shift amounts cross the horizontal axis in an upward sloping manner to the right near ±80 pixels and 0 pixel. FIG. 15D illustrates an enlarged view near the pixel with a shift amount of 0. In one or more embodiments, candidate dh1 for the image shift amount indicates −0.5 pixel, which is an intersection with the horizontal axis. Similarly, −80.5 pixel and +79.5 pixel are candidates for the image shift amount.

An image shift amount candidate, −0.5 pixel, is a pixel shift amount which occurs when the readout in FIG. 14B is performed in the flicker environment. One or more embodiments obtain information on the readout method illustrated in FIG. 14A or FIG. 14B as information on the driving of the image sensor 122 in S1301, thereby obtaining the image shift amount caused by flicker. For example, in the case of the drive method of FIG. 14B, information on −0.5 pixel is acquired. On the other hand, the image shift amounts at −80.5 pixel and +79.5 pixel are image shift amounts offset by −0.5 pixel caused by the influence of flicker from 80 pixel, which is the period during which flicker occurs, as understood from FIG. 15A. Canceling the image shift amount caused by the flicker influence can calculate that the period during which flicker occurs is 80 pixels, and the frequency of flicker can be calculated from the information on the readout time for each row. In S1305, it is determined whether the image shift amount of −0.5 pixel in a case where flicker occurs is included in the image shift amount candidates acquired in S1304, based on the readout information on the image sensor 122 in FIG. 14B. If included, it is determined that the environment is likely to be a flicker environment, and the flow proceeds to S1306. In S1306, in order to exclude cases where the defocus state of the object matches the image shift amount detected in the flicker environment, a difference with the horizonal focus detection result, which is less affected by flicker, is confirmed. In a case where a difference between the horizonal focus detection result and the vertical focus detection result is small, it is determined that the defocus state of the object can also be acquired from the vertical focus detection result. On the other hand, if the difference is large, it is determined that the vertical focus detection result is affected by flicker. Due to the determination in S1306, the focus detection using the vertical focus detection result can be performed in a wider range of imaging environments, and highly accurate focusing can be performed. Alternatively, the determination in S1306 may be omitted to minimize the influence of flicker on the vertical focus detection result.

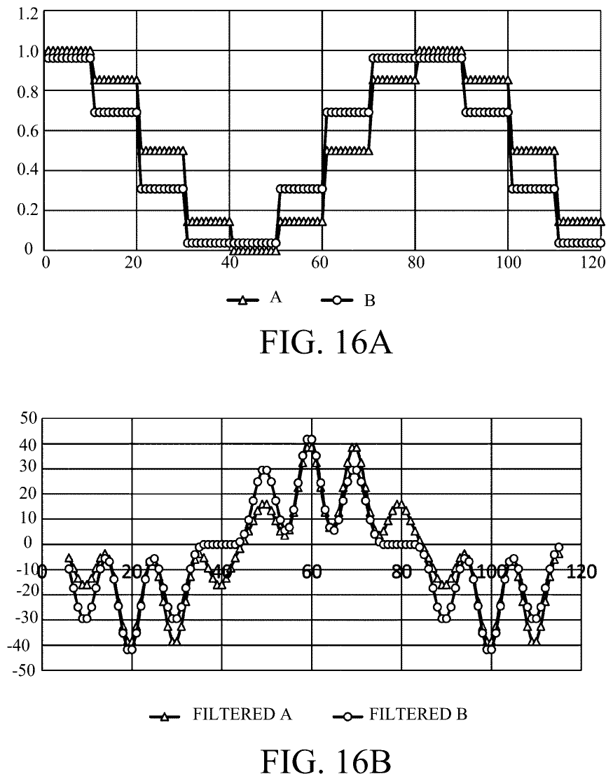

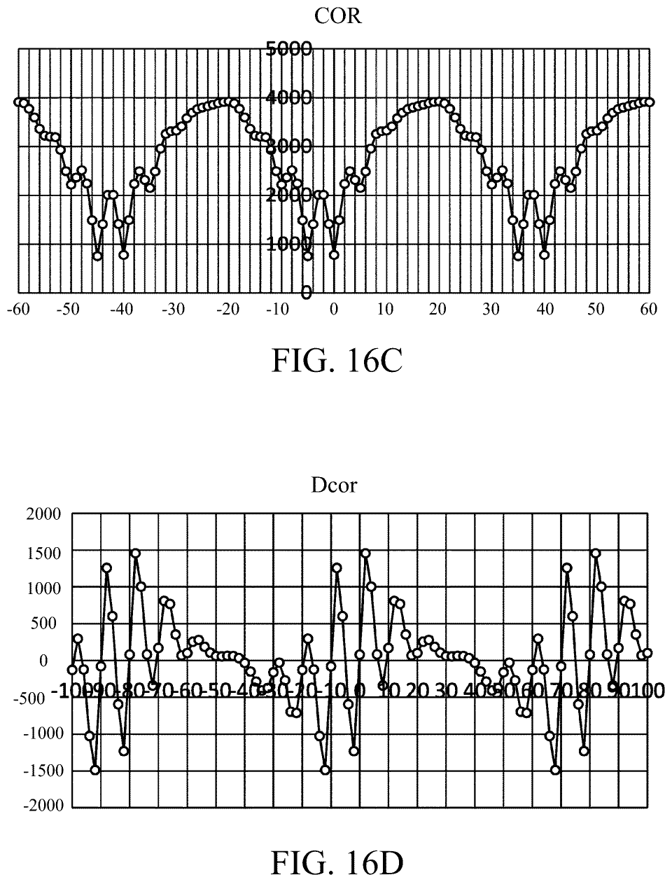

A description will be turned to FIG. 14C. FIG. 14C illustrates simultaneous reading of a plurality of rows of the image sensor 122. FIG. 14C illustrates simultaneous reading of four rows, but the number of simultaneously readable rows is not limited to this. Even when a plurality of rows are read out simultaneously, there is a difference between the readout period of the A-signal and the readout period of the (A+B)-signal, and there is a difference in the readout period for each block of rows (one block has four rows in FIG. 14C). FIGS. 16A, 16B, 16C, and 16D are other views illustrating waveforms in the flicker environment. For easy understanding, FIG. 16A illustrates the waveforms of the A-signal and the B-signal when 10 rows are read out simultaneously. In addition to the flicker influence, it can be understood that steps occur every 10 rows. In a case where the above correlation calculation is performed for such a waveform, a section of the shift amount having a small change in the correlation amount occurs, and a highly accurate image shift amount cannot be acquired, so digital filter processing is performed. FIG. 16B illustrates results of performing predetermined filter processing (−4, −11, −21, −28, −28, −17, 0, 17, 28, 28, 21, 11, 4). As in the correlation calculation processing described above, FIG. 16C illustrates a correlation amount COR, and FIG. 16D illustrates the difference value DCOR between correlation amounts. It is understood that the difference value DCOR between correlation amounts rises to the right and intersects the horizontal axis at approximately −90, −80, −10, 0, +70, and +80 pixels. Here, a shift amount of −10 pixel is an image shift amount caused by the influence of flicker when the image sensor 122 simultaneously reads out 10 rows. Similarly to the case of reading out every one row at a time described above, in S1301, acquired information regarding the driving of the image sensor 122 is simultaneous reading of 10 rows and an image shift amount caused by flicker of approximately −10 pixel. Thereafter, the determinations are performed in steps S1305 and S1306 as described above. Similarly, the frequency of flicker can be calculated from the shift amounts of +80 pixels and 0 pixel. It is also understood that the image shift amount candidates of −90 pixel and +70 pixel are image shift amounts resulting from the combination of the frequency of flicker and the influence of flicker caused by the readout method of the image sensor.

When a plurality of rows are read out simultaneously, an image shift occurs due to the difference Pa-ab between the readout periods of the A-signal and the (A+B)-signal, and an image shift occurs due to waveform steps that occur every multiple row. In a case where the influence of waveform steps occurring every multiple row is sufficiently reduced by the above digital filter processing, the former influence of the difference Pa-ab between the readout periods of the A-signal and the (A+B)-signal increases. For example, in a case where the waveform steps occurring every four rows are eliminated by digital filter processing in simultaneous four-row readout in FIG. 14C, an image shift of Pa-ab/Pa-a×4 pixels=1 pixel occurs. On the other hand, in a case where 10 rows are simultaneously read out in FIGS. 16A, 16B, 16C, and 16D, the waveform steps occurring every 10 rows do not disappear due to the digital filter processing. Therefore, an image shift amount of −10 pixel is calculated as the image shift amount candidate.

An image shift amount caused by the waveform step occurring for multiple rows that are simultaneously read out as described above is affected when the signals are read out of the image sensor 122 and added up for multiple rows. For example, in the case of simultaneous reading from 10 rows, the signals are read out, then signals from two rows are added up, then the length of the signal sequence (the number of signals) is compressed to half, and then a correlation calculation is performed. Then, the image shift amount candidate naturally has an image shift amount of +5 pixels (−5 pixels in the example described above). Therefore, the determination may be made based on the drive information on the image sensor 122 as well as the contents of the subsequent signal processing.

Thus, a value of an image shift amount at which the focus detection result is affected by flicker is previously calculated by a combination of the drive information on the image sensor 122 acquired in S1301 and the digital filter processing for the correlation calculation. Thereby, the image shift amount candidate can be compared in S1304.

The influence on the A-signal, B-signal, and vertical focus detection result under the flicker environment discussed with reference to FIGS. 14A to FIG. 16D correspond to a case where the object has no contrast and flicker occurs. In reality, the contrast including the defocus state of the object is superimposed on the A-signal and the B-signal. Therefore, in a case where the contrast of the object is low and a brightness difference of flicker is large, the influence of flicker on a vertical focus detection result increases, and a value close to an image shift amount described above occurs. On the other hand, in a case where the contrast of the object is high or in a case where the brightness difference of flicker is small in a mixed light environment with other flicker-free light sources, the influence of flicker on a vertical focus detection result is reduced, and a vertical focus detection result indicating a defocus state of an object can be acquired. Therefore, the determination in S1305 in FIG. 13 may assume that an image shift amount has an error to some extent under the flicker environment due to the readout method of the image sensor 122 and the digital filter. For example, in FIGS. 15A, 15B, 15C, and 15D, in a case where an image shift amount candidate for the vertical focus detection in a range of −0.5 pixel±0.25 pixel is acquired, a method of determining Yes can be considered.

As described above, the vertical focus detection result can contain errors under the flicker environment, but determining whether or not it can be used according to the drive information on the image sensor can avoid using less accurate vertical focus detection result. As a result, highly accurate focus detection can be performed.

One or more embodiments determine whether there is flicker influence for each focus detecting area. Flickers may occur due to the illumination in the entire imaging environment, or may occur only in a part of the imaging environment, such as a digital signage. As in one or more embodiments, by determining whether there is flicker influence for each focus detecting area, more vertical focus detection results can be used, and more accurate focus detection can be achieved.

On the other hand, as described above, the flicker influence on the vertical focus detection result varies according to the contrast of the object, including defocus. Therefore, a determination may be incorrect when only a single focus detecting area is used. Therefore, one conceivable method previously determines a threshold value, and uses none of the vertical focus detection results in a case where it is determined that there is flicker influence in a number of focus detecting areas greater than the threshold value. In a case where there is an uneven distribution of focus detecting areas affected by flicker, another conceivable method does not use the vertical focus detecting area in only a part of the imaging range. These methods can more reliably reduce errors due to flicker contained in the vertical focus detection result.

One or more embodiments determine the flicker influence using a correlation calculation, but the determination method is not limited to this example. The flicker environment may be determined based on the number of simultaneous readout rows, for example, in a case where the luminances of the signal sequences for each number of simultaneous readout rows are added up and compared, and a signal-amount difference is a predetermined value or greater. Alternatively, the flicker environment may be determined by comparing signals obtained with different drive states of the image sensor 122. In a case where the number of simultaneous readout rows or the read speed differs, the flicker influence on the signal also differs. The difference may be used for the flicker determination.

### Defocus Amount Selection Processing

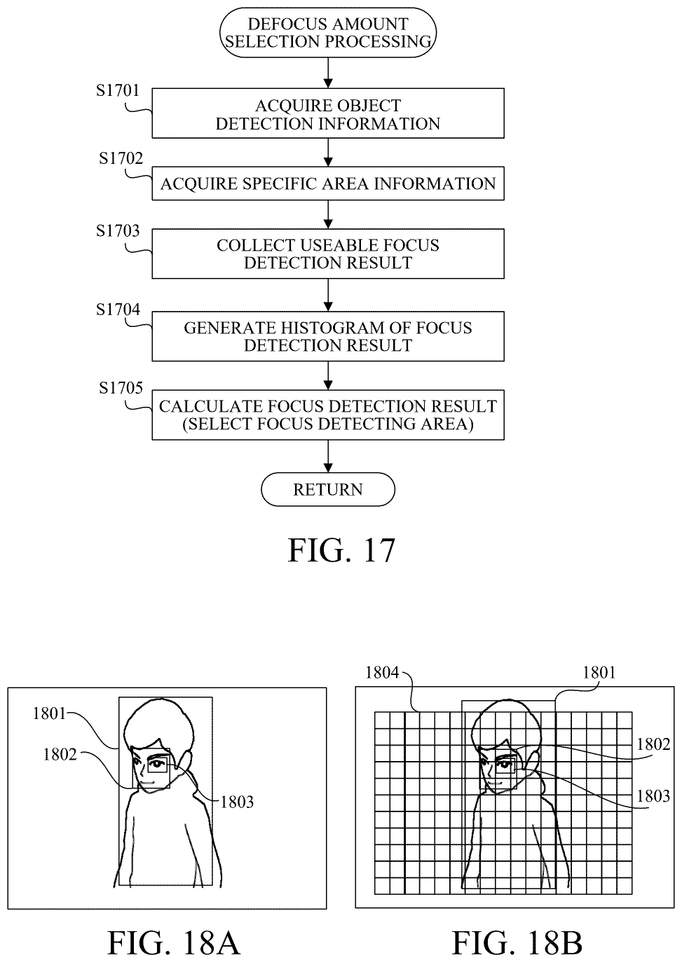

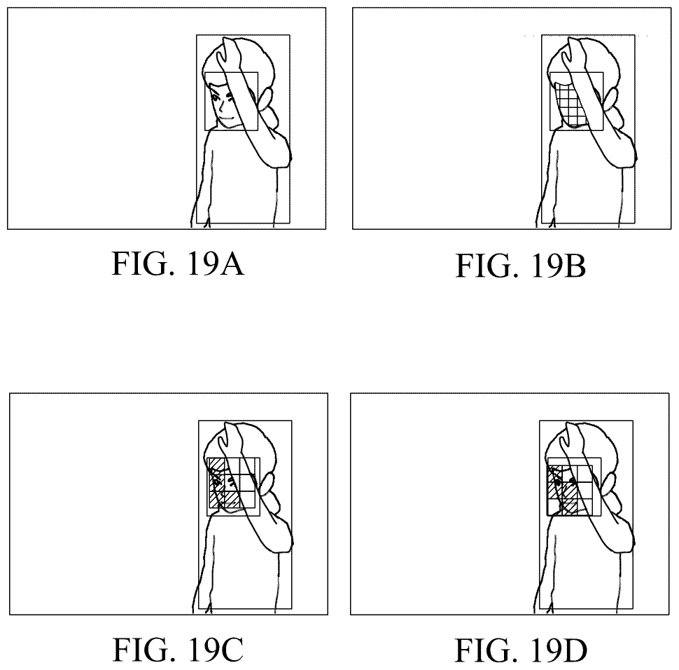

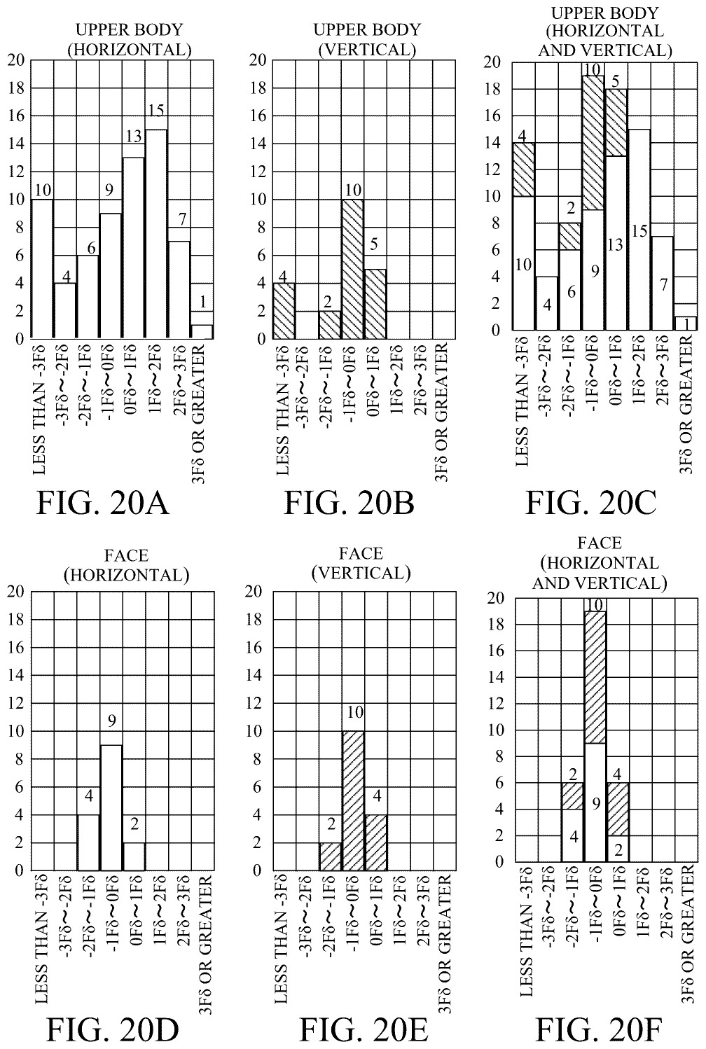

Referring now to FIG. 17 to FIG. 20D, a description will be given of a subroutine of the defocus amount selection processing subroutine according to one or more embodiments. FIG. 17 is a flowchart illustrating the defocus amount selection processing. FIGS. 18A, 18B, 18C, 18D, 18E, 18F, 18G, and 18H are views illustrating a method of setting a defocus map. FIGS. 19A, 19B, 19C, and 19D are other views illustrating a method of setting a defocus map, and illustrate examples of the arrangement of defocus maps in a case where occlusion occurs. FIGS. 20A, 20B, 20C, 20D, 20E, and 20F illustrate histograms of defocus maps.

In S1701, the camera MPU 125 acquires the object detection position and size, which are object detection information detected by the object detector 130.

In S1702, the camera MPU 125 acquires specific area information detected by the object detector 130. In one or more embodiments, the specific area information is a face area excluding an occluded area and a background area. The processing using the specific area information will be described later.

In S1703, the camera MPU 125 collects usable focus detection results. The collection of the usable focus detection results is processing of collecting defocus amounts as usable focus detection results in the defocus amount selection processing from the horizonal defocus map and the defocus amounts of the horizonal defocus map. More specifically, whether or not to allow all vertical focus detection results to be used is determined according to whether the number of focus detecting areas determined to be affected by flicker in the flicker determination processing of FIG. 13 described above is equal to or greater than a predetermined number. The reason why all vertical focus detection results are considered is that in a case where the predetermined number or more shows that there is flicker influence, there is a high possibility that the vertical focus detection results contain errors due to the flicker influence.

In a case where the contrast of the object is low, the ISO speed is high, or the exposure is darker than the proper exposure, the focus detection result is more erroneous. Thus, by determining the reliability of the focus detection result from a difference in the correlation amount in the correlation calculation processing described above, it may be determined not to be used for the focus detection result. By thinning out or adding the rows to be read out according to the drive method of the image sensor, the accuracy of the vertical focus detection result may be inferior to that of the horizonal focus detection result. Thus, in the case of an imaging mode using such a drive method, it may be determined not to use the vertical focus detection.

In S1704, the camera MPU 125 generates a histogram using defocus amounts, which are focus detection results that have been made usable in S1703. The histogram is generated by determining which focus detection result of a focus detecting area is to be used, based on the object detection information and specific area information. As illustrated in the focus detecting area setting processing in S2201 in FIG. 22 described above, the histogram is generated using the defocus map included in the object area.

Referring now to FIGS. 20A, 20B, and 20C, a description will be given of a method of generating a histogram using a defocus amount in an upper body detecting area.

FIG. 20A is a histogram generated from a defocus amount of a horizonal defocus map within the upper body detecting area of the person in FIG. 18B. FIG. 20B is a histogram generated from a defocus amount of a vertical defocus map within the upper body detecting area of the person in FIG. 18C. FIG. 20C is a histogram generated by combining the defocus amounts of the horizonal defocus map and the vertical defocus map within the upper body detecting area of the person in FIGS. 18B and 18C. The horizontal axis of the histogram represents classes which divide the defocus amount into certain ranges, and the vertical axis of the histogram is the frequency. In this example, the positive side of the defocus amount is set to a close distance (near) side and a negative side of the defocus amount is set to an infinity (far) side, and a defocus amount of a pupil region of a person is 0Fδ. In the horizonal histogram in FIG. 20A, a histogram is generated for the entire upper body detecting area, which mainly includes the left side area of the upper body below the face, and thus the maximum frequency of the histogram is located on the short distance side. Therefore, in a case where a defocus amount is selected from a defocus amount range that results in the maximum value of the histogram frequency, a selected defocus amount is different from the pupil region of the person on which the user wishes to focus. In the vertical histogram in FIG. 20B, since the vertical defocus map is placed in the face detecting area, it does not include the left side area of the upper body below the face, and therefore the frequency of the histogram in the range near 0Fδ, which is a defocus amount of the pupil region, is maximum. However, due to the small number of focus detecting areas in the defocus map, it may be difficult to extract a location that maximizes the frequency under the condition that the defocus amount is likely to vary due to errors. Accordingly, generating a histogram which combines the horizonal and vertical directions as illustrated in FIG. 20C can generate a histogram which uses more defocus amounts. Thus, it is possible to select a more suitable defocus amount in comparison with defocus-amount variations or an erroneous defocus amount. However, this is a defocus-amount histogram in the upper body detecting area, and thus it also includes the left side area of the upper body below the face. Thus, the frequency of the defocus-amount histogram increases in the ranges of −1Fδ to 0Fδ and 0Fδ to 1Fδ, and it becomes difficult to extract a defocus-amount range that maximizes the frequency of the histogram. As a result, depending on the defocus-amount variation, the defocus-amount range that maximizes the frequency of the histogram may fluctuate.

A method of generating a histogram using the defocus amount by setting the face detecting area as the defocus amount selecting area will be described with reference to FIGS. 20D, 20E, and 20F. An example will be given in which the defocus amount of the pupil region of a person is 0Fδ.

FIG. 20D is a histogram generated from a defocus amount of the horizonal defocus map within the person's face detecting area in FIG. 18B. Since the histogram based on the defocus amount is generated within the face detecting area, the frequency of the defocus-amount histogram becomes maximum in a range from −1Fδ to 0Fδ, which includes the defocus amount of the person's pupil region.

FIG. 20E is a histogram generated from a defocus amount of a vertical defocus map within the person's face detecting area of FIG. 18D. Since the histogram based on the defocus amount is generated within the face detecting area, the frequency of the defocus-amount histogram becomes maximum in a range from −1Fδ to 0Fδ, which includes the defocus amount of the person's pupil region.

FIG. 20F is a histogram generated by combining the histograms of FIGS. 20D and 20E and thereby combining the defocus amounts of horizonal and vertical defocus amounts. Due to the histogram generated by combining the horizonal and vertical defocus amounts within the face detecting area, the frequency of the defocus-amount histogram in a range of −1Fδ to 0Fδ, which includes the defocus amount of the person's pupil region, becomes larger than the frequency of the defocus-amount histogram of only the horizonal or vertical defocus amount. Therefore, even if there is a defocus-amount variation or a defocus amount that causes perspective conflict with the background, they are less likely to be affected.

The defocus-amount histogram may be generatable using as many defocus amounts as possible in a narrow person detecting area. As illustrated in FIGS. 20D, 20E, and 20F, a histogram may be generated using defocus amounts of the horizonal and vertical defocus maps within the face detecting area. However, in a case where the area of the defocus map within the face detecting area is small, the number of defocus-amount data is small, so the frequency of the histogram using the defocus amount is low as a whole, and it becomes difficult to extract a range of defocus amounts where the frequency is maximum. Accordingly, in generating the histogram, the number of necessary defocus-amount data or the detecting area of a person is determined, and it is determined whether the number of defocus-amount data is equal to or greater than a predetermined value or the detecting area of a person is equal to or greater than a predetermined value. In a case where it is less than the predetermined value, the detecting area for a person is expanded so that the number of defocus-amount data becomes equal to or greater than the predetermined value. There is a difference between the area of the horizonal defocus map and the area of the vertical defocus map. Thus, for example, a histogram of the defocus amount may be generated by using the horizonal defocus map for an upper body detecting area of a person, and the vertical defocus map for a face detecting area of the person.

Depending on the detecting area of the person, the horizonal defocus map may have a defocus amount and the vertical defocus map may have no defocus amount. In a case where only the horizonal defocus map has a defocus amount, the number of defocus amounts may be twice or left as is, and in an area where both horizonal and vertical defocus maps are present, the number of defocus amounts may be left as is or may be halved and normalized. In one or more embodiments, the area of the horizonal defocus map is larger than the area of the vertical defocus map, but the area of the vertical defocus map may be larger than the area of the horizonal defocus map.

In S1705, the camera MPU 125 selects a focus detecting area using the histogram of defocus amounts, which is the focus detection result generated in S1704, and selects a defocus amount corresponding to a focus detection result of that area. The defocus amount is selected from a range that maximizes the frequency of the defocus-amount histogram. There are a plurality of selection methods. For example, the selection method may be a method for selecting a defocus amount closest to the defocus amount that is the predictive AF processing result in S406, a method for selecting a defocus amount in a focus detecting area that is close in position to the pupil detecting area, which is the detecting area for a person, or a method for selecting a defocus amount on the short distance side. The selection method may be a method for producing a defocus-amount histogram for each of a plurality of detecting areas, such as an upper body, a face, and an eye, and for selecting a defocus amount from ranges that maximize the frequencies of the histograms of the plurality of detecting areas, or a plurality of defocus amounts from the short distance side.

The selection method may be a method for calculating a defocus amount by averaging defocus amounts in a range that maximizes the frequency of the defocus-amount histogram.

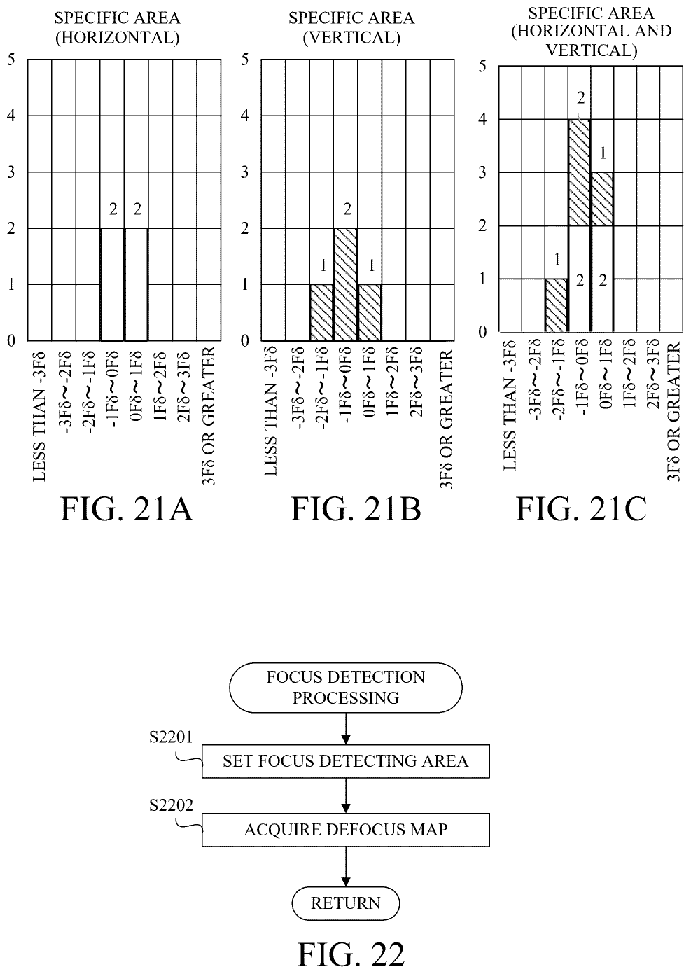

Next, processing using specific area information will be described with reference to FIGS. 19A, 19B, 19C, and 19D. FIG. 19A illustrates an image of the moment when a person's face area is covered with an occluded area (arm), and the object detection information acquired in S1701 is indicated by a rectangular frame. FIG. 19B illustrates the specific area (face area in one or more embodiments) acquired in S1702 as a lattice frame, and indicates that a portion covered by the arm has not been detected as the specific area (face area). The specific area information (likelihood) acquired in S1702 may be information which expresses whether or not it is a specific area with a binary output result of 1 or 0, or it may be information which expresses that the larger the value is, the higher the likelihood is in one byte, for example, 0 to 255. One or more embodiments use the former method, assuming that 1 is output for the lattice frame area and 0 is output for other areas such as the arm. FIG. 19C illustrates effective areas as the specific area in the horizonal defocus map using diagonal lines by associating the 3×3-frame horizonal defocus map with the specific area. The determination as to whether or not it is effective may use a determination method of determining whether or not the proportion of the estimated area within each frame of the defocus map is equal to or greater than a certain value, for example, equal to or greater than 50%. The range within each frame may be determined based on parameters that are used for the correlation calculation, such as the shift amount that has been used to calculate the defocus amount. FIG. 19D illustrates effective areas as the specific area in the vertical defocus map using diagonal lines by associating the 3×3-frame vertical defocus map with the specific area. The determination as to whether or not it is effective may use a determination method similar to that of the horizonal defocus map, and thus a description thereof will be omitted. FIGS. 21A, 21B, and 21C are histograms generated from the defocus maps of FIGS. 19C and 19D. Since the 3×3-frame defocus map includes occluded areas, if a histogram is generated for the entire area, due to the influence of the occluded areas, a histogram peak is more likely to be detected on a short distance side of the face. On the other hand, generating the histogram only in the specific area as in one or more embodiments can reduce the influence of the occluded area, background area, and the like.

As described above, by generating the histogram only in the specific area, an effect of suppressing the influence of the occluded area can be expected. One or more embodiments have discussed the 3×3-frame defocus map, but the number of frames can be freely set to N×M frames (where N and M are integers equal to or greater than 2).

### One or More Additional Embodiments

One or more additional embodiments will discuss a configuration different from that of at least one of the aforementioned embodiments, and will omit a description of the similar configuration.

### Defocus Amount Selection Processing

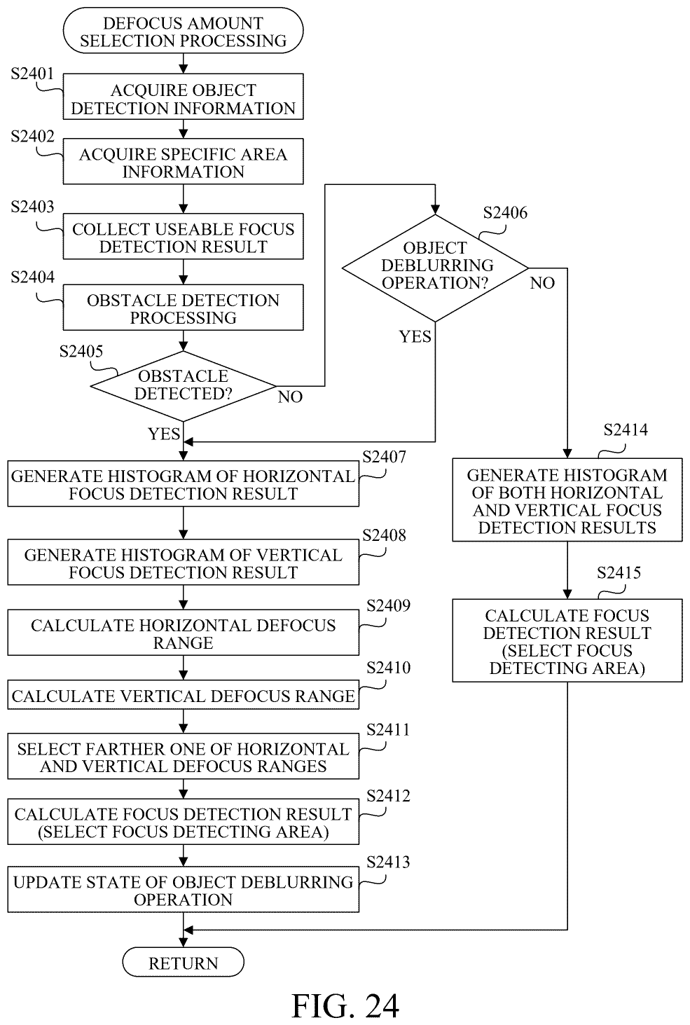

FIG. 24 is a flowchart of defocus amount selection processing.

In S2401, the camera MPU 125 acquires a position and size of a detected object as object information detected by the object detector 130.

In S2402, the camera MPU 125 acquires specific area information detected by the object detector 130. In one or more embodiments, the specific area information is a face area excluding an occluded area and a background area.

In S2403, usable focus detection results are collected. The specific processing is similar to S1703 described above, and a description thereof will be omitted.

In S2404, obstacle detection processing is performed. For example, an obstacle can be detected using the method disclosed in Japanese Patent Laid-Open No. 2021-176009.

In S2405, it is determined whether an obstacle has been detected, and in a case where the obstacle has been detected, the flow proceeds to S2407. In a case where no obstacle is detected, the flow proceeds to S2406 to determine whether or not there is a deblurring operation of the object (or object deblurring operation).

The deblurring operation of the object is an operation of changing the object from a blurred state after AF processing starts to an in-focused state. In a case where a defocus amount selected in the defocus amount selection processing becomes equal to or less than a predetermined amount (such as 1Fδ), the deblurring of the object is deemed to be completed. The deblurring operation is also redone if the object as an AF target changes during the AF processing. Enabling the predictive AF processing in S406 after the deblurring operation of the object is completed can provide persistent tracking of the object that has been deblurred once.

In a case where it is determined that the operation is the object deblurring operation, the flow proceeds to S2407, and in a case where it is not determined that the operation is the deblurring operation, the flow proceeds to S2414.

In S2407, a histogram is generated using the defocus amount as a horizontal focus detection result that was made available in S2403.

In S2408, a histogram is generated using the defocus amount as a vertical focus detection result that was made available in S2403.

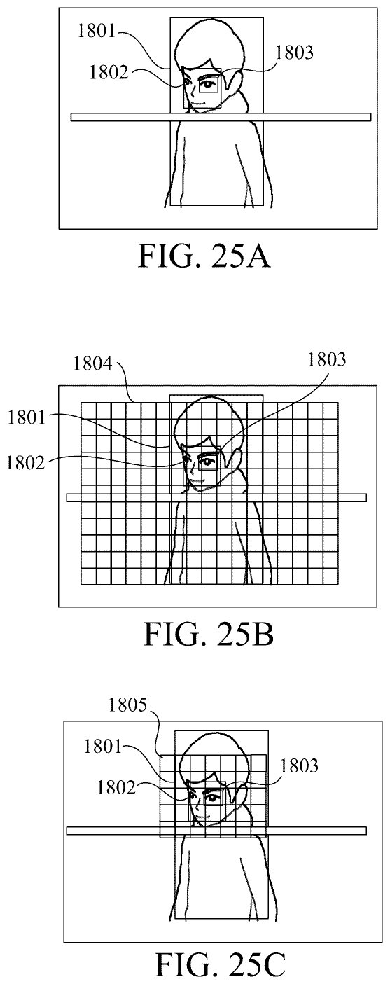

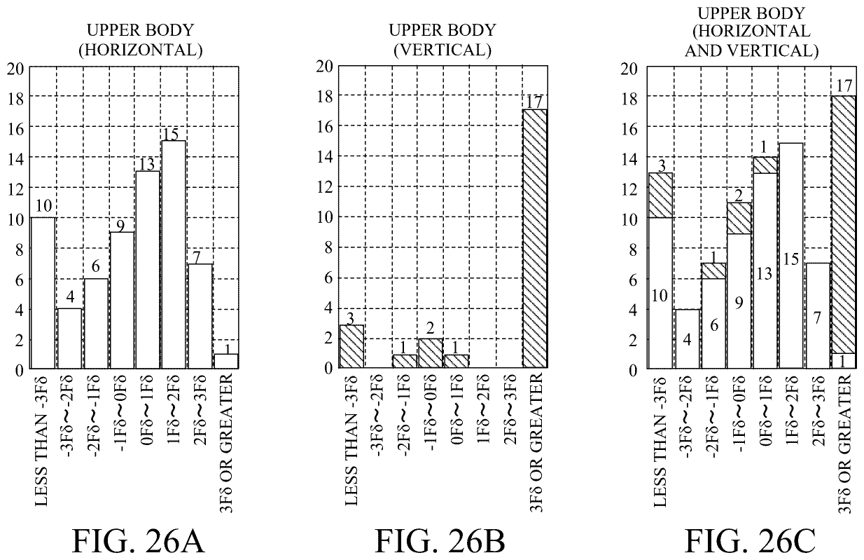

FIGS. 25A, 25B, and 25C illustrate a method for setting a defocus map, and illustrate examples of defocus map placement when there is a horizontal obstacle in front of an object. FIGS. 26A, 26B, and 26C illustrate histograms of defocus maps. The method of creating a histogram using the defocus amount is similar to the processing in S1704, and thus a description thereof will be omitted.

Since it is difficult to perform a focus detection of an object in a horizontal direction with a horizontal defocus map, the horizontal histogram in FIG. 26A is less affected.

The focus detection of an object in a horizontal direction can be possible with a vertical defocus map. Therefore, a defocus amount of an obstacle on a short distance side (close (distance) side) of the object may be detected, and the vertical histogram in FIG. 26B has the highest frequency of the histogram on the short distance side of 3Fδ or more.

FIG. 26C illustrates an example of a histogram generated by combining the horizontal and vertical defocus maps.

Even when the horizontal and vertical defocus maps are combined, the frequency of the histogram is maximum in the range of 3Fδ or more on the short distance side, which is the defocus amount of a horizontal-line obstacle.

In a case where there is a vertical-line obstacle, the vertical defocus map is less affected relative to the histogram, and the horizontal defocus map may detect a defocus amount of an obstacle on the short distance side of the object, maximizing the frequency of the histogram on the short distance side.

In S2409, a horizontal defocus range is calculated. Here, the range of 1Fδ to 2Fδ, which provides the maximum frequency in the horizontal histogram in FIG. 26A, is selected.

In S2410, a vertical defocus range is calculated. Here, the range of 3Fδ or more, which provides the maximum frequency in the vertical histogram in FIG. 26B, is selected.

In S2411, either the horizontal defocus range or the vertical defocus range is selected, but the defocus range on the far side is selected to reduce the influence of the obstacle.

In the examples of FIGS. 26A, 26B, and 26C, the defocus range with the maximum frequency in the horizontal histogram is located on the far side, so the range of 1Fδ to 2Fδ is selected.

The separate histograms are thus created from the horizontal and vertical focus detection results as described above based on the fact that obstacles in front of the object are often imaged together with obstacles that have a characteristic in the horizontal or vertical direction, as in imaging through a net in a baseball field or a volleyball net in watching sports, or imaging animals through a cage.

The selection method of S2411 is not limited to this example. One or more embodiments create the histogram for the object detecting area, so the influence of perspective conflict due to the background is considered to be small, and the far side is selected to avoid obstacles.

However, for a small object, a ratio of perspective conflict frames in the histogram increases. In a case where the far side is selected, it is highly likely that the background in-focus position causes the maximum frequency in either the horizontal focus detection result or the vertical focus detection result, so the short distance side may be selected.

The far side may be selected only in a case where it is determined that an obstacle exists, and the short distance side or maximum frequency may be selected in a case where no obstacle exists.

The selection method may also be changed according to a type of a detected object. For example, in a case where the detected object is an animal, the far side may be selected since it is easily affected by obstacles such as imaging through a cage, and in a case where it is not an animal, the short distance side or maximum frequency may be selected.

In an AF mode that does not use an object detecting area (such as automatic selection AF), if the far side is selected, it is highly likely that the background provides the maximum frequency. Therefore, in the AF mode that does not use an object detecting area, the short distance side may be selected.

In S2412, a focus detecting area is selected using the defocus amount selected in S2411, and the defocus amount, which is the focus detection result of that area, is selected. The focus detecting area may be selected from the focus detection result for one of the horizontal and vertical defocus maps selected in S2411, or from the focus detection results for both of the horizontal and vertical defocus maps. The specific method of selecting the defocus amount is similar to the processing of S1705 described above, and thus a description thereof will be omitted.

In S2405 and S2406, in a case where no obstacle is detected and the operation is not the object deblurring operation, the flow proceeds to S2414 to generate a histogram using both the horizontal and vertical focus detection results.

In S2415, a focus detecting area is selected using the histogram of the defocus amount, which is the focus detection result generated in S2414, and the defocus amount as the focus detection result for that area is selected. The processing contents of S2414 and S2415 are similar to those of S1704 and S1705 described above, and a description thereof will be omitted.

One or more embodiments separately generate a histogram using both the horizontal and vertical focus detection results in the case of the object deblurring operation. In a case where the deblurring operation has not yet been completed, the object is blurred and easily affected by obstacles. Therefore, it is advantageous to generate a histogram separately from both the horizontal and vertical focus detection results. On the other hand, after the deblurring operation has been completed, the object is in focus and is less likely to be affected by obstacles. Therefore, it is advantageous to generate a histogram of both the horizontal and vertical focus detection results.

In S2413, the state of the object deblurring operation is updated. More specifically, in a case where the defocus amount selected in the defocus amount selection processing becomes equal to or less than a predetermined value (such as 1Fδ), the object deblurring operation is considered to be in a completed state. In a case where the defocus amount becomes larger than a predetermined value (such as 1Fδ), the object deblurring operation is considered to be in an incomplete state, and the defocus amount selection processing ends.

As described above, by separately generating a histogram using horizontal and vertical defocus maps and specifying the defocus range, it is expected that the influence of an obstacle area having a characteristic in the horizontal or vertical direction can be prevented.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the present disclosure has described example embodiments, it is to be understood that the present disclosure is not limited to the example embodiments. The scope of the following claims is to be accorded the broadest interpretation so as to encompass all such modifications and equivalent structures and functions.

One or more embodiments of the present disclosure may provide a focus detecting apparatus, an image pickup apparatus, a focus detecting method, and a storage medium, each of which can select a defocus amount of an object by using defocus amounts in different focus detecting directions.

This application claims priority to Japanese Patent Application No. 2024-105619, which was filed on Jun. 28, 2024, and which is hereby incorporated by reference herein in its entirety.

What is claimed is:

1. A focus detecting apparatus comprising:
one or more processors that operate to:
perform a first focus detection using a signal from a first focus detecting pixel group in an image sensor having a plurality of focus detecting pixel groups that operate to receive light beams passing through different pupil regions in an imaging optical system, and a second focus detection using a signal from a second focus detecting pixel group having a pupil division direction different from that of the first focus detecting pixel group and being of the plurality of focus detecting pixel groups of the image sensor;
set a selected area from an area in which a plurality of focus detections are performed; and
select a first defocus amount of an object based on a result of using defocus amounts acquired by the first focus detection and the second focus detection in the selected area.

2. The focus detecting apparatus according to claim 1, wherein the one or more processors operate to select the first defocus amount based on information acquired by adding up the defocus amounts acquired by the first focus detection and the second focus detection in an area in which the defocus amounts acquired by the first focus detection and the second focus detection are present, and a defocus amount of one of the first focus detection and the second focus detection acquired in an area in which the one of the first focus detection and the second focus detection is performed.

3. The focus detecting apparatus according to claim 1, wherein a selected area in a case where the defocus amounts acquired by the first focus detection and the second focus detection are present is narrower than a selected area in a case where a defocus amount acquired by one of the first focus detection and the second focus detection is present.

4. The focus detecting apparatus according to claim 1, wherein the one or more processors operate to select the first defocus amount based on a histogram of a plurality of defocus amounts acquired in the selected area.

5. The focus detecting apparatus according to claim 4, wherein the one or more processors operate to select the first defocus amount from a range that maximizes a frequency of the histogram.

6. The focus detecting apparatus according to claim 4, wherein in forming the histogram, weights are different between information acquired by adding up the defocus amounts acquired by the first focus detection and the second focus detection acquired in an area in which the defocus amounts acquired by the first focus detection and the second focus detection are present and a defocus amount of one of the first focus detection and the second focus detection acquired in an area in which the one of the first focus detection and the second focus detection is performed.

7. The focus detecting apparatus according to claim 1, wherein the one or more processors operate to select the first defocus amount based on a result of using a first candidate based on the first focus detection in the selected area, a second candidate based on the second focus detection in the selected area, and the defocus amounts acquired by the first focus detection and the second focus detection in the selected area.

8. The focus detecting apparatus according to claim 7, wherein the one or more processors further operate to:
select the first candidate based on a histogram of a plurality of defocus amounts acquired by the first focus detection; and
select the second candidate based on a histogram of a plurality of defocus amounts acquired by the second focus detection.

9. The focus detecting apparatus according to claim 7, wherein, in a case where an obstacle to the object is present, the one or more processors operate to select the first defocus amount based on a result of using a defocus amount of one of the first candidate and the second candidate, which is farther from the focus detecting apparatus, and the defocus amounts acquired by the first focus detection and the second focus detection in the selected area.

10. The focus detecting apparatus according to claim 7, wherein the one or more processors operate to select the first defocus amount based on a result of using information on the object, a defocus amount of one of the first candidate and the second candidate, which is farther from or closer to the focus detecting apparatus, and the defocus amounts acquired by the first focus detection and the second focus detection in the selected area.

11. The focus detecting apparatus according to claim 7, wherein the one or more processors further operate to:
determine whether a deblurring operation of the object has been completed based on the first defocus amount previously selected;
select the first defocus amount, in a case where the deblurring operation has not yet been completed, based on a result of using the first candidate, the second candidate, and the defocus amounts acquired by the defocus amounts acquired by the first focus detection and the second focus detection in the selected area; and
select the first defocus amount, in a case where the deblurring operation has been completed, based on information acquired by adding up the defocus amounts acquired by the first focus detection and the second focus detection.

12. The focus detecting apparatus according to claim 7, wherein the one or more processors operate to:
select the first defocus amount, in a case where an obstacle to the object is present, based on a result of using a defocus amount of one of the first candidate and the second candidate which is located on a farther side of the focus detecting apparatus, and the defocus amounts acquired by the defocus amounts acquired by the first focus detection and the second focus detection in the selected area; and
select the first defocus amount, in a case where the obstacle is not present, based on information acquired by adding up the defocus amounts acquired by the first focus detection and the second focus detection.

13. The focus detecting apparatus according to claim 1, wherein the image sensor includes:
a first pixel having a red spectral sensitivity;
a second pixel having a green spectral sensitivity; and
a third pixel having a blue spectral sensitivity,
wherein pixels forming or of the first focus detecting pixel group are included in any one of the first pixel, the second pixel, and the third pixel, and
wherein pixels forming or of the second focus detecting pixel group are included in the second pixel.

14. An image pickup apparatus comprising:
the focus detecting apparatus according to claim 1; and
the image sensor.

15. A focus detecting method comprising:
performing a first focus detection using a signal from a first focus detecting pixel group in an image sensor having a plurality of focus detecting pixel groups that operate to receive light beams passing through different pupil regions in an imaging optical system, and a second focus detection using a signal from a second focus detecting pixel group having a pupil division direction different from that of the first focus detecting pixel group and being of the plurality of focus detecting pixel groups of the image sensor;
setting a selected area from an area in which a plurality of focus detections are performed; and
selecting a first defocus amount of an object based on a result of using defocus amounts acquired by the first focus detection and the second focus detection in the selected area.

16. A non-transitory computer-readable storage medium storing a program that causes a computer to execute the focus detecting method according to claim 15.
